(19) United States
(12) Patent Application Publication
(10) Pub. No.: US 2026/0048601 A1
(43) Pub. Date: Feb. 19, 2026

(54) RECORDING DEVICE AND RECORDING DEVICE CONTROL METHOD

(71) Applicant: SEIKO EPSON CORPORATION, Tokyo (JP)

(72) Inventors: Hiroyuki MAEDA, MATSUMOTO-SHI (JP); Chiaki SHIMADA, AZUMINO-SHI (JP)

(21) Appl. No.: 19/298,439

(22) Filed: Aug. 13, 2025

(30) Foreign Application Priority Data
Aug. 14, 2024 (JP) 2024-135310

(51) Int. Cl. B41J 13/00; B41J 2/165; B41J 3/60; B41J 11/00; B41J 13/03

(52) U.S. Cl. CPC B41J 13/0009; B41J 2/16517; B41J 3/60; B41J 11/0095; B41J 13/03

(57) ABSTRACT

The recording device includes a transport part, a recording part, and a control part that controls the transport part and the recording part. A inversion path is a path for re-transporting a medium to a recording path in a state where a front and back of the medium transported along the recording path are inverted. In a case where the transport part sequentially transports the first medium and the second medium and the recording part performs recording on both surfaces of at least the first medium, the control part transports the second medium on which recording is performed on the first surface by the recording part to the inversion path during a state where the first medium on which recording is performed on the first surface by the recording part is stopped in the inversion path, and re-transports the first medium from the inversion path to the recording path.

### BACKGROUND

The present application is based on, and claims priority from JP Application Serial Number 2024-135310, filed Aug. 14, 2024, the disclosure of which is hereby incorporated by reference herein in its entirety.

### 1. Technical Field

The present disclosure relates to a recording device and a recording device control method.

### 2. Related Art

For example, as described in JP-A-2005-280897, a recording device is disclosed that records on both surfaces of a medium transported along a transport path. The transport path includes a recording path where recording is performed on the medium and an inversion path for re-transporting the medium in an inverted state to the recording path again. Such a recording device is configured to, when recording is performed on both surfaces of the medium, control transport speed at which the medium is transported in the recording path independently of the transport speed at which the medium is transported in the inversion path. By this, throughput can be improved by recording on the medium in accordance with the size of the medium.

However, in such a recording device, it is desired to improve user convenience by further improving throughput.

### SUMMARY

A recording device that overcomes the above problem includes a transport part configured to transport a medium in a transport direction along a transport path; a recording part configured to record an image on the medium transported by the transport part; and a control part configured to control the transport part and the recording part, wherein the transport path includes a recording path and an inversion path, the recording path is a path in which the recording part records on the medium, the inversion path is a path configured to re-transport the medium that was transported following the recording path, again through the recording path in a state in which front and rear surfaces of the medium are inverted, when the transport part sequentially transports a first medium and a second medium in this order and also the recording part performs recording on both surfaces of at least the first medium, the control part causes the second medium on which a first surface thereof was recorded on by the recording part to be transported to the inversion path during a state in which the first medium on which a first surface thereof was recorded on by the recording part is stopped in the inversion path and causes the first medium to be re-transported from the inversion path to the recording path.

A recording device control method that overcomes the above problem is for a recording device that includes a transport part configured to transport a medium in a transport direction along a transport path; a recording part configured to record an image on the medium transported by the transport part; and the transport path includes a recording path and an inversion path, the recording path is a path in which the recording part records on the medium, the inversion path is a path configured to re-transport the medium that was transported following the recording path, again through the recording path in a state in which front and rear surfaces of the medium are inverted, the recording device control method including when the transport part sequentially transports a first medium and a second medium in this order and also the recording part performs recording on both surfaces of at least the first medium, causing the second medium on which a first surface thereof was recorded on by the recording part to be transported to the inversion path during a state in which the first medium on which a first surface thereof was recorded on by the recording part is stopped in the inversion path and causing the first medium to be re-transported from the inversion path to the recording path.

### BRIEF DESCRIPTION OF THE DRAWINGS

FIG. 1 is a schematic view showing a recording device of a first embodiment.

FIG. 2 is a block diagram showing electrical configuration of the recording device of the first embodiment.

FIG. 3 is a schematic view showing a control pattern of the first embodiment.

FIG. 4 is a schematic view showing the recording device of the first embodiment.

FIG. 5 is a schematic view showing the recording device of the first embodiment.

FIG. 6 is a schematic view showing the recording device of the first embodiment.

FIG. 7 is a timing chart illustrating a third control pattern of the first embodiment.

FIG. 8 is a timing chart illustrating a second control pattern of the first embodiment.

FIG. 9 is a timing chart illustrating a first control pattern according to the first embodiment.

FIG. 10 is a flowchart illustrating a double-sided recording control process according to the first embodiment.

FIG. 11 is a flowchart showing a double-sided recording control process according to a second embodiment.

FIG. 12 is a schematic view showing a control pattern of a third embodiment.

### DESCRIPTION OF EMBODIMENTS

### First Embodiment

Hereinafter, an embodiment of a recording device and a recording device control method will be described with reference to the drawings. In the drawings, the direction of gravity is indicated by the Z axis and the directions along the horizontal plane are indicated by the X axis and the Y axis, assuming that the recording device is placed on the horizontal plane. The X-axis, the Y-axis, and the Z-axis are orthogonal to each other.

### Configuration of Recording Device 11

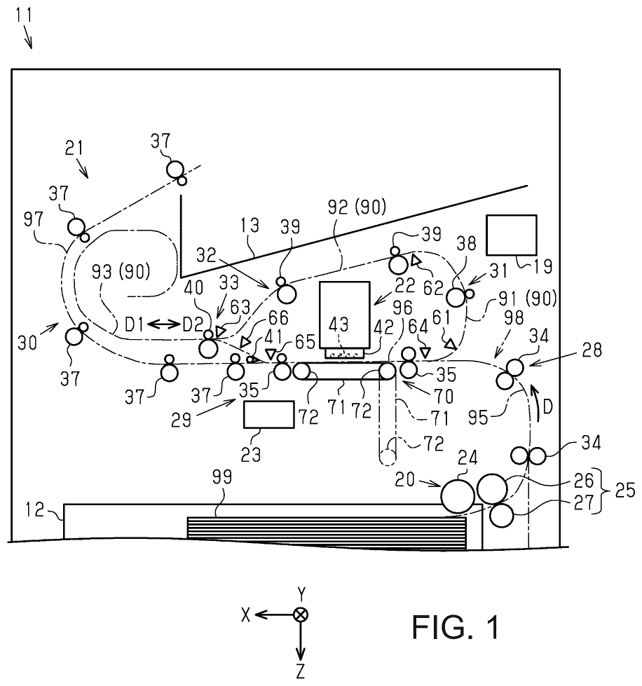

As shown in FIG. 1, the recording device 11 is configured to record an image on a medium 99. The recording device 11 may be, for example, an ink jet printer that records an image by ejecting ink, which is an example of a liquid, onto the medium 99.

The recording device 11 may include one or more medium accommodation parts 12. The medium accommodation part 12 can accommodate plural sheets of the medium 99 in a stacked state. The recording device 11 may include a stacker 13. The stacker 13 receives the recorded medium 99.

The recording device 11 may include a transport path 98. The transport path 98 is a path through which the medium 99 is transported. In the drawings, the transport path 98 is indicated by single dot chain line. In the present embodiment, the direction in which the medium 99 is transported is also referred to as a transport direction D. The transport direction D is a direction along the transport path 98. In the present embodiment, upstream means upstream in the transport direction D, and downstream means the downstream in the transport direction D.

The recording device 11 may include a feeding part 20, a transport part 21, a recording part 22, and a maintenance part 23. The feeding part 20 feeds out the medium 99 stored in the medium accommodation part 12 to the transport path 98 one sheet at a time. That is, the feeding part 20 feeds the medium 99 accommodated in the medium accommodation part 12 to the transport part 21.

The feeding part 20 may include a feed roller 24 and a separation part 25. The feeding part 20 may include the same number of feed rollers 24 and the same number of separation parts 25 as the number of medium accommodation parts 12.

The feed roller 24 rotates in a state of being in contact with the medium 99 accommodated in the medium accommodation part 12, and by this feeds the medium 99 out to the transport path 98. The feed roller 24 is located at an upstream end of the transport path 98.

The separation part 25 may include a separation drive roller 26 and a separation driven roller 27. The separation drive roller 26 and the separation driven roller 27 are in contact with each other in a state where the medium 99 is not present between them.

A rotational load is applied to the separation driven roller 27 by, for example, a torque limiter. In a case where the separation part 25 sandwiches plural sheets of the medium 99, the separation driven roller 27 is more difficult to drive to rotate with respect to the separation drive roller 26 that is being driven to rotate. By this, the separation part 25 separates, one sheet at a time, the medium 99 that was fed out by the feed roller 24. The feeding part 20 feeds the medium 99 one sheet at a time using the separation drive roller 26 and the separation driven roller 27.

The transport part 21 is configured to transport the medium 99 along the transport path 98. The transport path 98 may include a supply path 95, a recording path 96, a discharge path 97, and a inversion path 90. The inversion path 90 may include a first inversion path 91, a second inversion path 92, and a third inversion path 93.

The supply path 95 is a path through which passes the medium 99 before recording. The supply path 95 is a path connecting the medium accommodation part 12 and the recording part 22. The supply path 95 is located at the most upstream position of the transport path 98. The supply path 95 is located upstream of the recording path 96. The supply path 95 is a path for transporting the not yet recorded on medium 99 to the recording path 96.

The recording path 96 is a path for the recording part 22 to perform recording on the medium 99. The recording path 96 is a path along the recording part 22. The recording path 96 is a path for transporting the medium 99 on which recording is performed by the recording part 22. The recording path 96 is located downstream of the supply path 95.

The discharge path 97 is a path for transporting the medium 99 after recording. The discharge path 97 is a path connecting the recording part 22 and the stacker 13. The discharge path 97 is located downstream of the recording path 96. The discharge path 97 is a path for discharging the medium 99 transported from the recording path 96 to the stacker 13.

The inversion path 90 is a path connecting a downstream end of the recording path 96 and an upstream end of the recording path 96. The inversion path 90 is a path for returning the medium 99 that has been recorded on one side, to further upstream than the recording part 22. The inversion path 90 is a path for inverting the medium 99. Specifically, the inversion path 90 is a path for inverting the medium 99 so that the front surface of the medium 99 on which recording has been performed earlier faces downward. By this, the medium 99 that was re-transported to the recording path 96 is transported such that the rear surface on which recording was not performed faces the recording part 22. In this way, the inversion path 90 is a path for re-transporting the medium 99 to the recording path 96 in a state where the medium 99 transported along the recording path 96 is inverted upside down.

The inversion path 90 is longer than twice the maximum-length medium 99 that can be transported by the transport part 21 in the transport direction D. The inversion path 90 is longer than three times the minimum-length medium 99 that can be transported by the transport part 21 in the transport direction D.

The first inversion path 91 is located downstream of the second inversion path 92 in the inversion path 90. The first inversion path 91 is a path for re-transporting the medium 99 from the second inversion path 92 to the recording path 96.

The second inversion path 92 is located downstream of the third inversion path 93 in the inversion path 90. The second inversion path 92 is a path for re-transporting the medium 99 from the third inversion path 93 to the recording path 96. The second inversion path 92 is a path for transporting the medium 99 from the third inversion path 93 to the first inversion path 91.

The third inversion path 93 is a path for transporting the medium 99 from the recording path 96 and inverting the medium 99. The third inversion path 93 is a path for transporting the medium 99 from the recording path 96 to the first transport direction D1, and then transporting the medium 99 to the second inversion path 92 by transporting the medium 99 to the second transport direction D2 in a state where the medium 99 is inverted. The third inversion path 93 is a switchback path.

The first inversion path 91 is longer than the minimum-length medium 99 that can be transported by the transport part 21 in the transport direction D. The second inversion path 92 is longer than the minimum-length medium 99 that can be transported by the transport part 21 in the transport direction D. The total length of the first inversion path 91 and the second inversion path 92 is longer than the maximum-length medium 99 that can be transported by the transport part 21 in the transport direction D. The third inversion path 93 is longer than the maximum-length medium 99 that can be transported by the transport part 21 in the transport direction D.

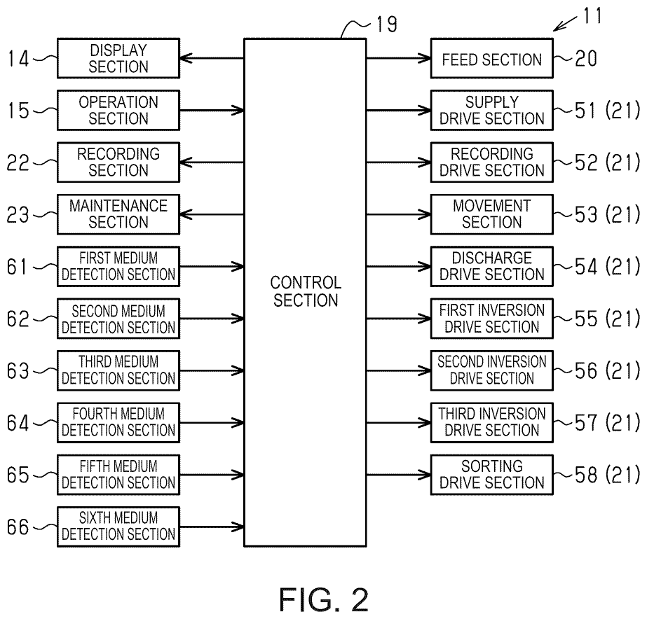

The transport part 21 includes a supply part 28, a recording transport part 29, a discharge part 30, a first inversion transport part 31, a second inversion transport part 32, and a third inversion transport part 33. The supply part 28 is configured to transport the medium 99 along the supply path 95. The supply part 28 includes at least one supply roller pair 34. The supply roller pair 34 is provided at a position along the supply path 95. The supply roller pair 34 is rotated by driving force from a supply drive part 51 shown in FIG. 2. By this, the supply roller pair 34 transports the medium 99 along the supply path 95.

The recording transport part 29 is configured to transport the medium 99 along the recording path 96. The recording transport part 29 includes at least one transport roller pair 35. The recording transport part 29 may include transport roller pairs 35 on the upstream side and the downstream side of the recording region of the recording part 22. The transport roller pair 35 is provided at a position along the recording path 96. The transport roller pair 35 is rotated by driving force from a recording drive part 52 shown in FIG. 2. By this, the transport roller pair 35 transports the medium 99 along the recording path 96. The transport roller pair 35 may be a registration roller pair that corrects skew of the medium 99.

The recording transport part 29 includes a medium support part 70. The medium support part 70 is configured to transport the medium 99 in a state of supporting the medium 99 in the recording path 96. The medium support part 70 is provided at a position facing the recording part 22 with the recording path 96 interposed therebetween.

The medium support part 70 may include an endless transport belt 71 and a pulley pair 72. The transport belt 71 is stretched between a pulley pair 72. The transport belt 71 faces the recording part 22 with the recording path 96 interposed therebetween. The transport belt 71 supports a part of the medium 99 in a flat state. The transport belt 71 transports the medium 99 along the recording path 96 by rotating in a state of attracting the medium 99. One of the pulleys 72 is rotated by driving force from the recording drive part 52 shown in FIG. 2. By this, the transport belt 71 transports the medium 99 along the recording path 96.

The recording transport part 29 rotates about one of the pulleys 72 by driving force from a movement part 53 shown in FIG. 2. The transport belt 71 is provided so that by rotating about one of the pulleys 72, it is movable between a support position indicated by solid line in FIG. 1 and a retracted position indicated by two dot chain line in FIG. 1. The support position is a position at which the medium 99 is supported and caused to face the recording part 22. The retracted position is a position separated from the recording part 22.

The discharge part 30 is configured to transport the medium 99 along the discharge path 97. The discharge part 30 includes at least one discharge roller pair 37. The discharge roller pair 37 is provided at a position along the discharge path 97. The discharge roller pair 37 is rotated by driving force from a discharge drive part 54 shown in FIG. 2. By this, the discharge roller pair 37 transports the medium 99 along the discharge path 97.

The first inversion transport part 31 is configured to transport the medium 99 along the first inversion path 91. The first inversion transport part 31 includes at least one first inversion roller pair 38. The first inversion roller pair 38 is provided at a position along the first inversion path 91. The first inversion roller pair 38 is rotated by driving force from a first inversion drive part 55 shown in FIG. 2. By this, the first inversion roller pair 38 transports the medium 99 along the first inversion path 91.

The second inversion transport part 32 is configured to transport the medium 99 along the second inversion path 92. The second inversion transport part 32 includes at least one second inversion roller pair 39. The second inversion roller pair 39 is provided at a position along the second inversion path 92. The second inversion roller pair 39 is rotated by driving force from a second inversion drive part 56 shown in FIG. 2. By this, the second inversion roller pair 39 transports the medium 99 along the second inversion path 92.

The third inversion transport part 33 is configured to transport the medium 99 along the third inversion path 93. The third inversion transport part 33 includes at least one third inversion roller pair 40. The third inversion roller pair 40 is provided at a position along the third inversion path 93. The third inversion roller pair 40 is rotated by driving force from a third inversion drive part 57 shown in FIG. 2. By this, the third inversion roller pair 40 transports the medium 99 along the third inversion path 93.

The transport part 21 may include a sorting part 41. The sorting part 41 is provided at a branching position where the recording path 96 branches into the discharge path 97 and the inversion path 90. The sorting part 41 guides the medium 99 from the recording path 96 to one of the discharge path 97 and the inversion path 90. The sorting part 41 may be a flap.

The sorting part 41 is movable between a discharge position and an inversion position by driving force from a sorting drive part 58 shown in FIG. 2. The discharge position is a position at which the sorting part 41 guides the medium 99 from the recording path 96 to the discharge path 97. The inversion position is a position at which the sorting part 41 guides the medium 99 from the recording path 96 to the inversion path 90. Specifically, the inversion position is a position at which the sorting part 41 guides the medium 99 from the recording path 96 to the third inversion path 93.

The recording device 11 may include a first medium detection part 61, a second medium detection part 62, a third medium detection part 63, a fourth medium detection part 64, a fifth medium detection part 65, and a sixth medium detection part 66. The first medium detection part 61, the second medium detection part 62, the third medium detection part 63, the fourth medium detection part 64, the fifth medium detection part 65, and the sixth medium detection part 66 are provided along the transport path 98. The first medium detection part 61, the second medium detection part 62, the third medium detection part 63, the fourth medium detection part 64, the fifth medium detection part 65, and the sixth medium detection part 66 may be physical sensors or optical sensors.

The first medium detection part 61 is located at the downstream end of the first inversion path 91. The first medium detection part 61 is configured to detect the front edge of the medium 99 transported to the first inversion path 91. That is, the first medium detection part 61 detects that the medium 99 has been transported to the first inversion path 91. The first medium detection part 61 detects that the medium 99 has been transported to the downstream end of the first inversion path 91. In other words, the first medium detection part 61 detects that the medium 99 has been transported to a position just before the recording path 96.

The second medium detection part 62 is located at the downstream end of the second inversion path 92. The second medium detection part 62 is configured to detect the front edge of the medium 99 transported to the second inversion path 92. That is, the second medium detection part 62 detects that the medium 99 has been transported to the second inversion path 92. The second medium detection part 62 detects that the medium 99 has been transported to the downstream end of the second inversion path 92. In other words, the second medium detection part 62 detects that the medium 99 has been transported to a position just before the first inversion path 91.

The third medium detection part 63 is located upstream of the third inversion roller pair 40 in the third inversion path 93. The third medium detection part 63 is configured to detect the rear edge of the medium 99 transported to the third inversion path 93. That is, the third medium detection part 63 is configured to detect the front edge of the medium 99 switched back from the third inversion path 93 to the second inversion path 92. In this way, the third medium detection part 63 detects that the medium 99 has been transported to the third inversion path 93. In other words, the third medium detection part 63 detects that the medium 99 from the recording path 96 is accommodated in the third inversion path 93.

The fourth medium detection part 64 is provided at an upstream end of the recording path 96. The fourth medium detection part 64 is located upstream of the upstream side transport roller pair 35 in the recording path 96. The fourth medium detection part 64 is configured to detect the front edge of the medium 99 transported from the supply path 95 or the first inversion path 91 to the recording path 96. That is, the fourth medium detection part 64 detects that the medium 99 arrives at the transport roller pair 35.

The fifth medium detection part 65 is provided at the downstream end of the recording path 96. The fifth medium detection part 65 is located downstream of the downstream side transport roller pair 35 in the recording path 96. The fifth medium detection part 65 is located upstream of a branching position at which the recording path 96 branches into the discharge path 97 and the inversion path 90. The fifth medium detection part 65 is configured to detect the front edge of the medium 99 transported to the branch position. That is, the fifth medium detection part 65 detects that the medium 99 arrives at the branch position.

The sixth medium detection part 66 is located at the upstream end of the third inversion path 93. The sixth medium detection part 66 is configured to detect the rear edge of the medium 99 transported to the third inversion path 93. That is, the sixth medium detection part 66 is configured to detect the medium 99 at the branching position from the recording path 96 to the third inversion path 93.

The recording part 22 is configured to perform recording on the medium 99 transported by the transport part 21. The recording part 22 may include an ejection part 42 that ejects liquid onto the medium 99. The ejection part 42 may include a plurality of nozzles 43 that eject the liquid. The recording part 22 may perform recording by ejecting a liquid.

The ejection part 42 is a line head, but may be a serial head. A line head is a head that extends in the Y-axis direction and is capable of ejecting liquid all at once accross the entire medium 99 in the Y-axis direction. A serial head is a head capable of ejecting liquid onto the medium 99 while moving in the Y-axis direction. In this way, the recording part 22 is configured to extend along the Y-axis direction, which intersects the transport direction D, but is not limited to this. The Y-axis direction corresponds to an example of a width direction. In the recording part 22, the transport direction D is along the X-axis direction.

The maintenance part 23 is configured to perform maintenance of the recording part 22. The maintenance part 23 may be provided so as to be movable in a state where the medium support part 70 is located at the retracted position. The maintenance part 23 may perform maintenance of the recording part 22 by moving to a position facing or contacting the recording part 22.

The maintenance part 23 may perform, for example, flushing as maintenance of the recording part 22. Flushing is maintenance in which liquid in a droplet shape is ejected so as to be blown out from the nozzle 43. The maintenance part 23 may receive the liquid ejected from the nozzle 43 in association with the flushing. Flushing is performed, for example, before, during, or after recording.

The maintenance part 23 may perform, for example, capping as the maintenance of the recording part 22. Capping is maintenance for preventing the nozzles 43 from drying by covering the nozzles 43. Capping is executed, for example, at times other than the time of recording. The maintenance part 23 may perform, for example, cleaning as the maintenance of the recording part 22. Cleaning is maintenance for sucking the liquid from the nozzles 43. The maintenance part 23 may receive the liquid discharged from the nozzle 43 in accordance with cleaning.

The recording device 11 includes a control part 19. The control part 19 comprehensively controls the recording device 11. The control part 19 controls various operations performed by the recording device 11. The control part 19 can be configured by calculates α: one or more processors that execute various processes according to a computer program, β: one or more dedicated hardware circuits that execute at least a part of various processes, or γ: a combination of these. The hardware circuit is, for example, an application-specific integrated circuit. The processor includes a CPU and a memory, such as a RAM and a ROM, and the memory stores program code or instructions configured to cause the CPU to execute processes. Memory or computer readable medium includes any readable medium that can be accessed by a general-purpose or dedicated computer.

### Electrical Configuration of Recording Device 11

As shown in FIG. 2, the recording device 11 includes a display part 14 and an operation part 15. The display part 14 displays various types of information. The control part 19 causes the display part 14 to display various types of information. The operation part 15 can be operated by a user. The control part 19 receives an instruction from the user through the operation part 15. The recording device 11 may be capable of communicating with a terminal device (not shown). The control part 19 may receive an instruction from the user via the terminal device.

The transport part 21 includes the supply drive part 51, the recording drive part 52, the movement part 53, the discharge drive part 54, the first inversion drive part 55, the second inversion drive part 56, the third inversion drive part 57, and the sorting drive part 58. That is, the recording device 11 includes the supply drive part 51, the recording drive part 52, the movement part 53, the discharge drive part 54, the first inversion drive part 55, the second inversion drive part 56, the third inversion drive part 57, and the sorting drive part 58. The supply drive part 51, the recording drive part 52, the movement part 53, the discharge drive part 54, the first inversion drive part 55, the second inversion drive part 56, the third inversion drive part 57, and the sorting drive part 58 may be motors.

The supply drive part 51 is provided in the supply part 28. The supply drive part 51 is a driving source for rotating the supply roller pair 34. That is, the supply drive part 51 transports the medium 99 in the supply path 95.

The recording drive part 52 is provided in the recording transport part 29. The recording drive part 52 is a drive source for rotating the transport roller pair 35 and one of the pulleys 72. That is, the recording drive part 52 transports the medium 99 in the recording path 96.

The movement part 53 is provided in the recording transport part 29. The movement part 53 is a driving source for rotating the recording transport part 29 around one of the pulleys 72. That is, the movement part 53 moves the recording transport part 29 between the support position and the retracted position.

The discharge drive part 54 is provided in the discharge part 30. The discharge drive part 54 is a driving source for rotating the discharge roller pair 37. That is, the discharge drive part 54 transports the medium 99 in the discharge path 97.

The first inversion drive part 55 is provided in the first inversion transport part 31. The first inversion drive part 55 is a driving source for rotating the first inversion roller pair 38. That is, the first inversion drive part 55 transports the medium 99 in the first inversion path 91.

The second inversion drive part 56 is provided in the second inversion transport part 32. The second inversion drive part 56 is a driving source for rotating the second inversion roller pair 39. That is, the second inversion drive part 56 transports the medium 99 in the second inversion path 92.

The third inversion drive part 57 is provided in the third inversion transport part 33. The third inversion drive part 57 is a driving source for rotating the third inversion roller pair 40. That is, the third inversion drive part 57 transports the medium 99 in the third inversion path 93.

The sorting drive part 58 is a drive source for moving the sorting part 41 between the discharge position and the inversion position. That is, the sorting drive part 58 sorts the medium 99 from the recording path 96 to either the discharge path 97 or the third inversion path 93.

The control part 19 controls the feeding part 20, the transport part 21, the recording part 22, and the maintenance part 23. The control part 19 receives detection signals from the first medium detection part 61, the second medium detection part 62, the third medium detection part 63, the fourth medium detection part 64, the fifth medium detection part 65, and the sixth medium detection part 66.

When the control part 19 receives a recording job, the control part 19 controls the feeding part 20, the transport part 21, the recording part 22, and the maintenance part 23 so as to record an image on the medium 99. In particular, when the control part 19 receives a recording job including double-sided recording, the control part 19 controls the feeding part 20, the transport part 21, the recording part 22, and the maintenance part 23 so as to record images on both sides of the medium 99.

In particular, the control part 19 controls the recording part 22 to record an image on the medium 99 by ejecting liquid onto the medium 99 based on the timing at which the fourth medium detection part 64 detects the front edge of the medium 99. When the front edge of the medium 99 is detected by the fifth medium detection part 65, the control part 19 controls the sorting drive part 58 so as to guide the medium 99 from the recording path 96 to either the discharge path 97 or the third inversion path 93.

In a case where the front edge of the medium 99 is detected by the first medium detection part 61, the control part 19 can stop the medium 99 in the first inversion path 91 by controlling the first inversion drive part 55 to stop transport of the medium 99. In a case where the front edge of the medium 99 is detected by the second medium detection part 62, the control part 19 can stop the medium 99 in the second inversion path 92 by controlling the second inversion drive part 56 to stop transport of the medium 99. In a case where the rear edge of the medium 99 is detected by the third medium detection part 63, the control part 19 can stop the medium 99 in the third inversion path 93 by controlling the third inversion drive part 57 to stop transport of the medium 99.

### Control Table at the Time of Double-Sided Recording

In the case of double-sided recording, the control part 19 controls the feeding part 20, the transport part 21, and the recording part 22 based on a control table for double-sided recording. The control table is stored in the memory. The control table is referred to by the control part 19.

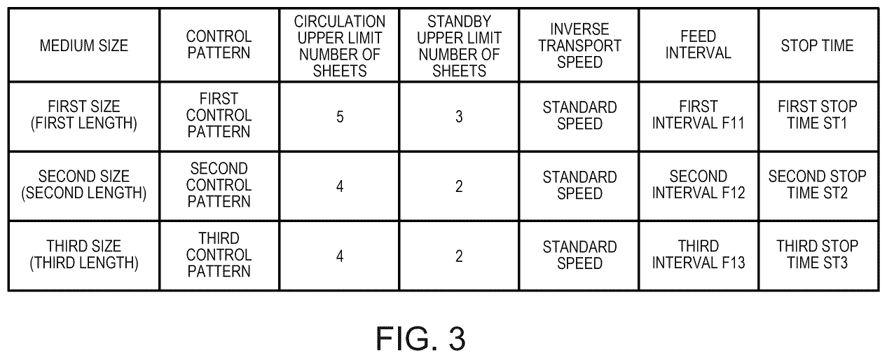

As shown in FIG. 3, the control table is a data table in which the size of the medium 99 and the control pattern are associated with each other. The size of the medium 99 may be classified into a first size, a second size, and a third size.

The first size is a size in which the length of the medium 99 in the transport direction D is a first length. The second size is a size in which the length of the medium 99 in the transport direction D is a second length. The third size is a size in which the length of the medium 99 in the transport direction D is a third length.

The second length is longer than the first length. The third length is longer than the second length. The first length may be, for example, a length less than 216 mm. The second length may be, for example, a length of 216 mm or more and less than 297 mm. The third length may be, for example, a length equal to or longer than the 297 mm.

The control patterns are patterns related to control of the feeding part 20, the transport part 21, and the recording part 22. The control patterns are stored in the memory. The control part 19 controls the feeding part 20, the transport part 21, and the recording part 22 based on the control patterns.

The control patterns include a first control pattern, a second control pattern, and a third control pattern. The first control pattern is referred to when the medium 99 is the first size. The second control pattern is referred to when the medium 99 is the second size. The third control pattern is referred to when the medium 99 is the third size.

The control pattern includes a circulation upper limit number of sheets, a standby upper limit number of sheets, an inverse transport speed, a feed interval, and a stop time. The circulation upper limit number of sheets is the number of sheets of the medium 99 that can exist in the transport path 98. Specifically, the circulation upper limit number of sheets is the number of sheets of the medium 99 that can exist in the supply path 95, the recording path 96, the discharge path 97, and the inversion path 90. The standby upper limit number of sheets is the number of sheets of the medium 99 that can exist in the inversion path 90. That is, the standby upper limit number of sheets is the number of sheets of the medium 99 in the inversion path 90 whose transport can be stopped.

In the first control pattern, the circulation upper limit number of sheets is set to five sheets, and the standby upper limit number of sheets is set to three sheets. In the second control pattern and the third control pattern, the circulation upper limit number of sheets is set to four sheets, and the standby upper limit number of sheets is set to two sheets. In this way, the circulation upper limit number of sheets and the standby upper limit number of sheets are set to be larger in the first control pattern than in the second control pattern or the third control pattern.

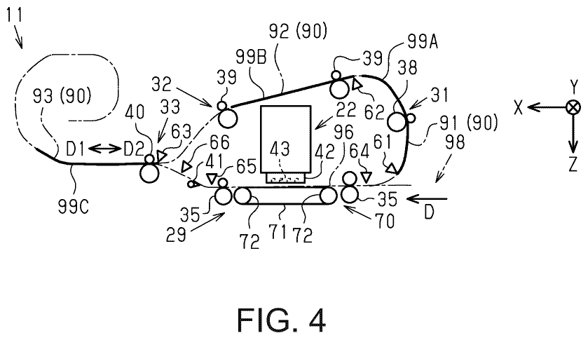

As shown in FIG. 4, in the first control pattern, a first medium 99A can be disposed in the first inversion path 91, a second medium 99B can be disposed in the second inversion path 92, and a third medium 99C can be disposed in the third inversion path 93.

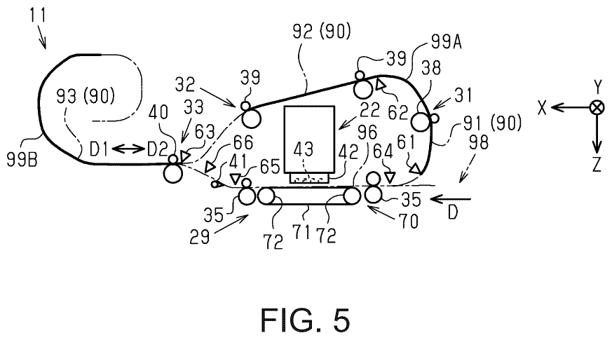

As shown in FIG. 5, in the second control pattern, the first medium 99A can be arranged in the first inversion path 91 and the second inversion path 92, and the second medium 99B can be arranged in the third inversion path 93. In the second control pattern, the front edge of the first medium 99A is located at the downstream end of the first inversion path 91, and the rear edge of the first medium 99A is located midstream of the second inversion path 92. In the second control pattern, when the second medium 99B is transported in the first transport direction D1, the rear edge of the second medium 99B is located at the upstream end of the third inversion path 93. In other words, in the second control pattern, when the second medium 99B is transported in the second transport direction D2, the front edge of the second medium 99B is positioned at the upstream end of the third inversion path 93.

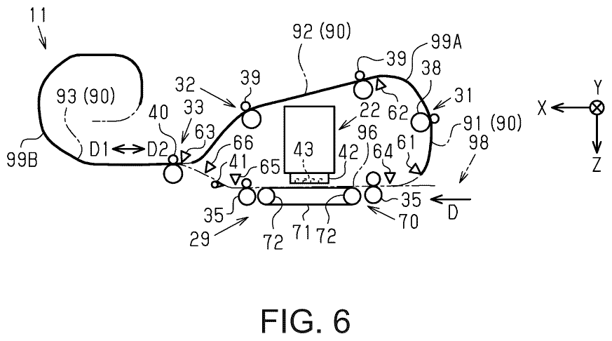

As shown in FIG. 6, in the third control pattern, the first medium 99A can be disposed in the first inversion path 91 and the second inversion path 92, and the second medium 99B can be disposed in the third inversion path 93. In the third control pattern, the front edge of the first medium 99A is positioned at the downstream end of the first inversion path 91, and the rear edge of the first medium 99A is positioned at the downstream end of the second inversion path 92. In the third control pattern, when the second medium 99B is transported in the first transport direction D1, the rear edge of the second medium 99B is located at the upstream end of the third inversion path 93. In other words, in the second control pattern, when the second medium 99B is transported in the second transport direction D2, the front edge of the second medium 99B is positioned at the upstream end of the third inversion path 93. Therefore, the distance between the rear edge of the first medium 99A and the front edge of the second medium 99B is greater in the second control pattern than in the third control pattern.

As shown in FIG. 3, the inverse transport speed is a speed at which the medium 99 is transported in the inversion path 90. The inverse transport speed may include a standard speed. The standard speed is the same transport speed as in the supply path 95, the recording path 96, and the discharge path 97.

In the present embodiment, the inverse transport speed is set as the standard speed in the first control pattern, the second control pattern, and the third control pattern. In this way, the same inverse transport speed is set in the first control pattern, the second control pattern, and the third control pattern.

The feed interval is an interval at which the medium 99 is fed from the medium accommodation part 12 to the transport part 21 by the feeding part 20. The stop time includes a time at which the medium 99 is stopped in the first inversion path 91. When the first control pattern is referred to, the stop time may include a time at which the medium 99 is stopped in the second inversion path 92. The feed interval and the stop time are in a correspondence relationship. Therefore, the stop time is a time based on the feed interval. The feed interval is a time based on the stop time.

### Control Patterns

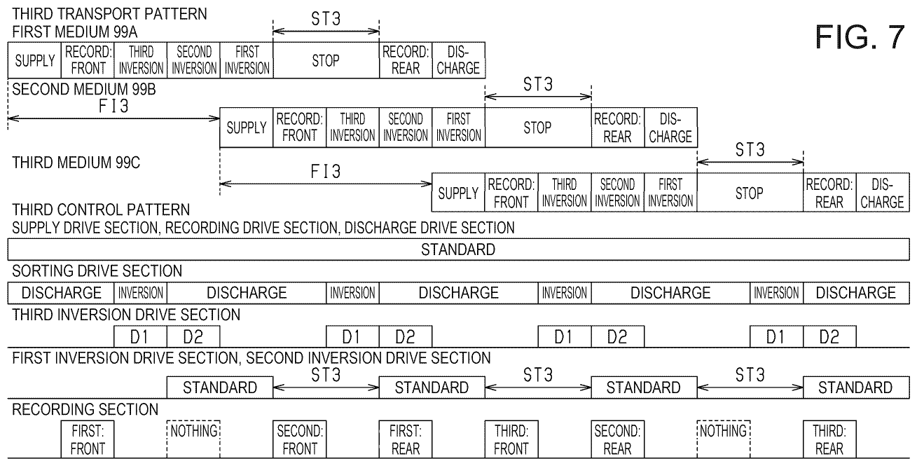

As shown in FIGS. 7 to 9, feeding of the medium 99, transport of the medium 99, and recording on the medium 99 are performed based on the control patterns. Each control pattern is a pattern for transporting each sheet of medium 99 like each transport pattern. Transport patterns are patterns for transporting the medium 99 along the transport path 98. In FIGS. 7 to 9, the length of each path constituting the transport path 98 in the transport direction D is schematically illustrated for easy understanding of the disclosure. The control patterns are not limited to these. Hereinafter, the control patterns and the transport patterns will be described on the premise that maintenance is not being performed. The front surface of the medium 99 corresponds to an example of a first surface, and the rear surface of the medium 99 corresponds to an example of a second surface.

### Third Control Pattern

With reference to FIG. 7, a specific example wherein the medium 99 is the third size will be described in which the first medium 99A, the second medium 99B, and the third medium 99C are transported in this order, and recording is performed on both sides.

As shown in FIG. 7, in a case where the medium 99 is the third size, feeding of the medium 99, transport of the medium 99, and recording on the medium 99 are performed based on the third control pattern. The third control pattern is a pattern for transporting each sheet of medium 99 as in the third transport pattern.

The third transport pattern is a pattern in which the medium 99 fed to the transport part 21 is transported from the supply path 95 to the recording path 96. In this case, an image is recorded on the front surface of the medium 99 in the recording path 96. The third transport pattern is a pattern in which the medium 99 recorded with an image on its front surface is transported from the recording path 96 to the third inversion path 93.

The third transport pattern is a pattern in which the medium 99 recorded with an image on its front surface is transported to the third inversion path 93 and then, in a state in which the medium 99 is inverted, transported from the third inversion path 93 to the second inversion path 92 and the first inversion path 91 in this order.

The third transport pattern is a pattern in which the medium 99 recorded with an image on the front surface is stopped in the first inversion path 91 and the second inversion path 92 for a third stop time ST3 and then the medium 99 is re-transported to the upstream end of the recording path 96. In this case, an image is recorded on the rear surface of the medium 99 in the recording path 96. The third transport pattern is a pattern in which the medium 99 recorded with an image on its rear surface is transported from the recording path 96 to the discharge path 97.

The third control pattern is a pattern in which plural sheets of medium 99 are fed to the transport part 21 at the third feed interval FI3. The third control pattern is a control pattern in which an image is recorded in a third recording order each time the front edge of the medium 99 is detected by the fourth medium detection part 64. The third recording order is the order of the front surface of the first medium 99A, the front surface of the second medium 99B, the rear surface of the first medium 99A, the front surface of the third medium 99C, the rear surface of the second medium 99B, and the rear surface of the third medium 99C.

The third control pattern is a pattern for controlling the feeding part 20, the supply drive part 51, the recording drive part 52, and the discharge drive part 54 so as to transport the medium 99 at the standard speed in the supply path 95, the recording path 96, and the discharge path 97.

The third control pattern is a pattern for controlling the sorting drive part 58 so as to guide the medium 99 from the recording path 96 to any one of the inversion path 90 and the discharge path 97 when the front edge of the medium 99 is detected upstream of the branch position by the fifth medium detection part 65. The third control pattern is a pattern for guiding the medium 99 on which recording was performed on the front surface, from the recording path 96 to the inversion path 90. The third control pattern is a pattern for guiding the medium 99, on the rear surface of which recording has been performed, from the recording path 96 to the discharge path 97. The third control pattern is a pattern in which the sorting part 41 is moved to the inversion position in a case where the medium 99 is to be guided to the inversion path 90, and the sorting part 41 is moved to the discharge position in other cases. However, a pattern may be adopted in which the sorting part 41 is moved to the discharge position when the medium 99 is to be guided to the discharge path 97, and the sorting part 41 is moved to the inversion position in other cases.

The third control pattern is a pattern for controlling the third inversion drive part 57 so as to transport the medium 99 at the standard speed in the first transport direction D1 without driving the first inversion drive part 55 and the second inversion drive part 56, in the case when the medium 99 is to be transported from the recording path 96 to the third inversion path 93.

The third control pattern is a pattern for controlling the first inversion drive part 55, the second inversion drive part 56, and the third inversion drive part 57 so as to transport the medium 99 at the standard speed from the third inversion path 93 to the second inversion path 92 and the first inversion path 91 in this order. In particular, the third control pattern is a pattern for controlling the third inversion drive part 57 so as to transport the medium 99 in the third inversion path 93 in the second transport direction D2 at the standard speed when the medium 99 is to be transported from the third inversion path 93 to the second inversion path 92.

The third control pattern is a pattern for controlling the first inversion drive part 55 and the second inversion drive part 56 so as to re-transport the medium 99 to the recording path 96 after the medium 99 is stopped during the third stop time ST3 in the first inversion path 91 and the second inversion path 92. In particular, in the third control pattern, the third stop time ST3 is determined so that the medium 99 is re-transported to the recording path 96 at the timing when the medium 99 from the recording path 96 is accommodated in the third inversion path 93.

The third control pattern is a pattern in which the first medium 99A in the first inversion path 91 and the second inversion path 92 are re-transported to the recording path 96, and the second medium 99B in the third inversion path 93 is transported to the second inversion path 92 and the first inversion path 91 in this order. In particular, the third control pattern is a pattern in which the medium 99 is transported from the third inversion path 93 to the second inversion path 92 at a timing at which the medium 99 is re-transported to the recording path 96.

### Second Control Pattern

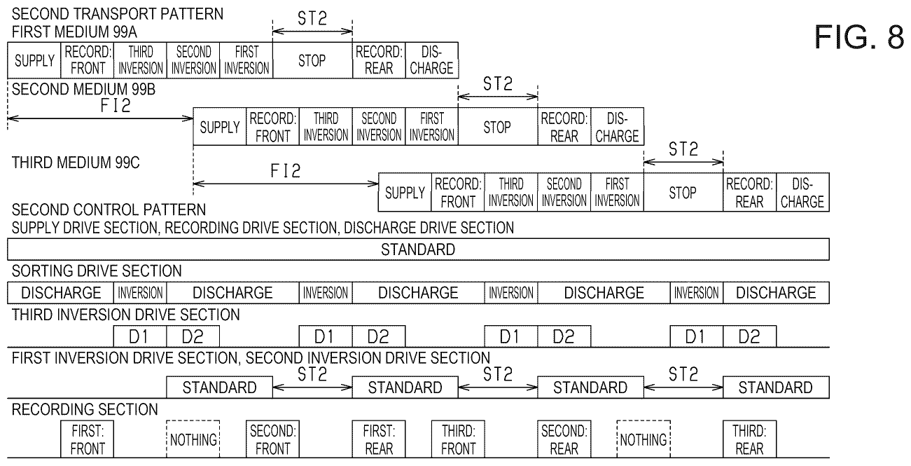

With reference to FIG. 8, a specific example wherein the medium 99 is the second size will be described in which the first medium 99A, the second medium 99B, and the third medium 99C are transported in this order and recording is performed on both sides. Hereinafter, points different from the third control pattern and the third transport pattern will be mainly described, and the description of the same points as the third control pattern and the third transport pattern will be omitted.

As shown in FIG. 8, in a case where the medium 99 is the second size, feeding of the medium 99, transport of the medium 99, and recording on the medium 99 are performed based on the second control pattern. The second control pattern is a pattern for transporting each of the plurality of medium 99 as per the second transport pattern.

The second transport pattern is a pattern in which the medium 99 recorded with an image on its front surface is stopped in the first inversion path 91 and the second inversion path 92 during the second stop time ST2, and then the medium 99 is re-transported to the upstream end of the recording path 96.

The second control pattern is a pattern in which plural sheets of medium 99 are fed to the transport part 21 at the second feed interval FI2. The second control pattern is a control pattern in which an image is recorded in a second recording order each time the front edge of the medium 99 is detected by the fourth medium detection part 64. The second recording order may be the same order as the third recording order.

The second control pattern is a pattern for controlling the first inversion drive part 55 and the second inversion drive part 56 so as to re-transport the medium 99 to the recording path 96 after stopping the medium 99 in the first inversion path 91 and the second inversion path 92 during the second stop time ST2.

### First Control Pattern

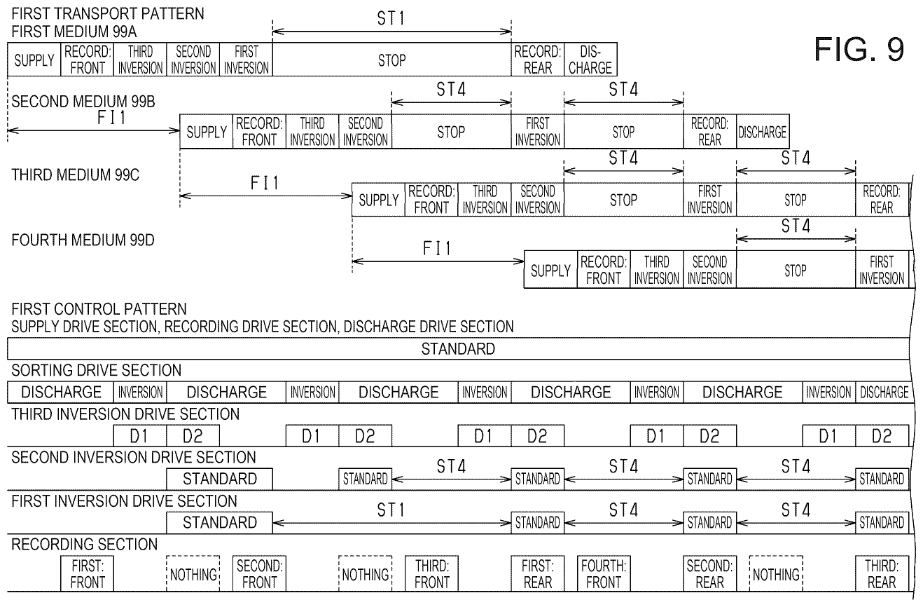

With reference to FIG. 9, a specific example wherein the medium 99 is the first size will be described in which the first medium 99A, the second medium 99B, the third medium 99C, and the fourth medium 99D are transported in this order and recording is performed on both sides. Hereinafter, points different from the third control pattern and the third transport pattern will be mainly described, and the description of the same points as the third control pattern and the third transport pattern will be omitted. The description of the recording on the rear surface of the fourth medium 99D is omitted. The description of the fourth medium 99D after stopping in the first inversion path 91 is omitted.

As shown in FIG. 9, when the medium 99 is the first size, feeding of the medium 99, transport of the medium 99, and recording on the medium 99 are performed based on the first control pattern. The first control pattern is a pattern for transporting each of the plurality of medium 99 as per the first transport pattern. The first transport pattern has different items depending on whether the first sheet of medium 99 is the target or the second or subsequent sheets of medium 99 are targets.

The first transport pattern is a pattern in which, when the first medium 99A is targeted, the medium 99 with an image recorded on its front surface is transported from the third inversion path 93 to the second inversion path 92 and the first inversion path 91 in this order in a state where the medium 99 is inverted. The first transport pattern is a pattern in which, when the first medium 99A is targeted, the medium 99 recorded with an image on its front surface is stopped in the first inversion path 91 during the first stop time ST1, and afterward the medium 99 is re-transported to the upstream end of the recording path 96.

The first transport pattern is a pattern in which, in a case where the second and subsequent sheets of the medium 99 are targeted, the medium 99 recorded with an image on its front surface is transported from the third inversion path 93 to the second inversion path 92 in a state where the medium 99 is inverted. The first transport pattern is a pattern in which, in the case where the second and subsequent sheets of medium 99 are targeted, the medium 99 is stopped in the second inversion path 92 during the fourth stop time ST4, and then afterward the medium 99 is transported to the first inversion path 91. The fourth stop time ST4 may be shorter than the first stop time ST1. The fourth stop time ST4 may be half the first stop time ST1. The first transport pattern is a pattern in which, in the case where the second and subsequent sheets of medium 99 are targeted, the medium 99 is stopped in the first inversion path 91 during the fourth stop time ST4, and then afterward the medium 99 is re-transported to the upstream end of the recording path 96.

The first control pattern is a pattern in which plural medium 99 are fed to the transport part 21 at the first feed interval FI1. The first control pattern is a control pattern in which an image is recorded in a first recording order each time the front edge of the medium 99 is detected by the fourth medium detection part 64. The first recording order is the order of the front surface of the first medium 99A, the front surface of the second medium 99B, the front surface of the third medium 99C, the rear surface of the first medium 99A, the front surface of the fourth medium 99D, the rear surface of the second medium 99B, the rear surface of the third medium 99C, and the rear surface of the fourth medium 99D.

The first control pattern is a pattern, with the first medium 99A as a target, for controlling the first inversion drive part 55, the second inversion drive part 56, and the third inversion drive part 57 so as to transport the medium 99 at the standard speed from the third inversion path 93 to the second inversion path 92 and the first inversion path 91 in this order. The first control pattern is a pattern, with the first medium 99A as a target, for controlling the first inversion drive part 55 so as to re-transport the medium 99 to the recording path 96 after the medium 99 is stopped in the first inversion path 91 for the first stop time ST1.

The first control pattern is a pattern, with the second and subsequent sheets of the medium 99 as the target, for controlling the second inversion drive part 56 and the third inversion drive part 57 so as to transport the medium 99 from the third inversion path 93 to the second inversion path 92 at the standard speed, without driving the first inversion drive part 55. The first control pattern is a pattern, with the second and subsequent sheets of medium 99 as the target, for controlling the first inversion drive part 55 and the second inversion drive part 56 so as to transport the medium 99 to the first inversion path 91 after the medium 99 is stopped in the second inversion path 92 for the fourth stop time ST4. In particular, the first control pattern is a pattern in which the first medium 99A in the first inversion path 91 is re-transported to the recording path 96, and the second medium 99B in the second inversion path 92 is transported to the first inversion path 91.

The first control pattern is a pattern, with the second and subsequent sheets of the medium 99 as the target, for controlling the first inversion drive part 55 so as to re-transport the medium 99 to the recording path 96 after stopping the medium 99 in the first inversion path 91 for the fourth stop time ST4. In particular, the first control pattern is also a pattern in which the second medium 99B in the first inversion path 91 is re-transported to the recording path 96 and the third medium 99C in the second inversion path 92 is transported to the first inversion path 91.

In this way, the first control pattern is a pattern for transporting the second medium 99B from the second inversion path 92 to the first inversion path 91 at the timing when the first medium 99A is re-transported to the recording path 96. The first control pattern is a pattern for transporting the third medium 99C from the third inversion path 93 to the second inversion path 92 at the timing when the second medium 99B is transported from the second inversion path 92 to the first inversion path 91.

The first feed interval FI1 may be shorter than the second feed interval FI2. The second feed interval FI2 may be shorter than the third feed interval FI3. By this, the period from when the medium 99 is re-transported from the inversion path 90 to the recording path 96 to when the next sheet of medium 99 is transported from the supply path 95 to the recording path 96 can be made longer in a case where the medium 99 is the second size than in a case where the medium 99 is the first size. The period from when the medium 99 is re-transported from the inversion path 90 to the recording path 96 to when the next medium 99 is transported from the supply path 95 to the recording path 96 can be made longer in a case where the medium 99 is the third size than in a case where the medium 99 is the second size. The second stop time ST2 may be shorter than the third stop time ST3. The third stop time ST3 may be shorter than the fourth stop time ST4. The third stop time ST3 may be shorter than the first stop time ST1.

### Double-Sided Recording Control Process

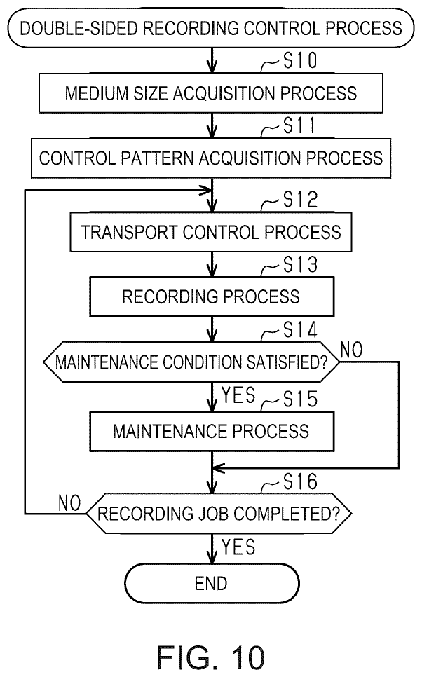

Next, a double-sided recording control process will be described with reference to FIG. 10. The double-sided recording control process is a process executed by the control part 19 when a recording job for performing double-sided recording is input. The recording job includes image data for recording on the medium 99. The recording job includes the size of the medium 99 on which an image is to be recorded. The recording job includes the number of sheets of the medium 99 on which images are to be recorded.

As shown in FIG. 10, in step S10, the control part 19 executes a medium size acquisition process. In the medium size acquisition process, the control part 19 acquires the size of the medium 99 from the inputted recording job. By this, the control part 19 acquires which of the first size, the second size, and the third size is the size of the medium 99 to be used for the double-sided recording.

In step S11, the control part 19 executes a control pattern acquisition process. In the control pattern acquisition process, the control part 19 obtains the control pattern corresponding to the medium size obtained in step S10 by reading the control pattern from the memory.

Specifically, when the size of the medium 99 is the first size, the control part 19 acquires the first control pattern from among the plurality of control patterns. When the size of the medium 99 is the second size, the control part 19 acquires the second control pattern from among the plurality of control patterns. When the size of the medium 99 is the third size, the control part 19 acquires the third control pattern from among the plurality of control patterns.

In step S12, the control part 19 executes a transport control process. In the transport control process, the control part 19 controls the feeding part 20 and the transport part 21 based on the control pattern acquired in step S11. Specifically, the control part 19 controls the feeding part 20, the supply drive part 51, the recording drive part 52, the discharge drive part 54, the first inversion drive part 55, the second inversion drive part 56, the third inversion drive part 57, and the sorting drive part 58 based on the control pattern and the detection signals from the plurality of medium detection parts.

In step S13, the control part 19 executes a recording process. In the recording process, the control part 19 controls the recording part 22 to record an image on the medium 99. Specifically, the control part 19 controls the recording part 22 to record an image on the medium 99 based on the control pattern acquired in step S11, and on the basis of timing at which the front edge of the medium 99 is detected by the fourth medium detection part 64.

In step S14, the control part 19 determines whether or not a maintenance condition is satisfied. The maintenance condition may be satisfied when the medium 99 is not present in the recording path 96. The maintenance condition may be satisfied at a predetermined cycle. The maintenance condition may be satisfied when the medium 99 is not present in the recording path 96 after a predetermined time has elapsed.

When the control part 19 determines that the maintenance condition is satisfied, the control part 19 shifts the process to step S15. When the control part 19 determines that the maintenance condition is not satisfied, the control part 19 shifts the process to step S16.

In step S15, the control part 19 executes a maintenance process. In the maintenance process, the control part 19 controls the maintenance part 23 to perform maintenance of the recording part 22. When the maintenance process is completed, the control part 19 shifts the process to step S16.

Specifically, the control part 19 controls the movement part 53 so as to move the medium support part 70 from the support position to the retracted position, and moves the maintenance part 23 so as to face the recording part 22. The control part 19 causes the maintenance part 23 to perform maintenance of the recording part 22. The control part 19 controls the movement part 53 so as to move the maintenance part 23 so as not to face the recording part 22 and to move the medium support part 70 from the retracted position to the support position.

In this way, the control part 19 stops transport of the medium 99 in the transport path 98 when the maintenance part 23 performs the maintenance of the recording part 22. That is, the control part 19 can stop transport of the medium 99 in at least a part of the supply path 95, the discharge path 97, and the inversion path 90.

In particular, when the maintenance part 23 performs maintenance of the recording part 22, the control part 19 stops transport of the medium 99 in the supply path 95, the discharge path 97, and the inversion path 90. By this, the control part 19 extends the stop time for stopping the medium 99 in the inversion path 90. That is, when stopping transport of the medium 99 in at least one of the supply path 95, the discharge path 97, and the inversion path 90, the control part 19 changes the stop time for stopping the medium 99 in the inversion path 90.

In step S16, the control part 19 determines whether or not the recording job is completed. When the control part 19 determines that the recording job is completed, the control part 19 ends the double-sided recording control process. When the control part 19 determines that the recording job is not completed, the control part 19 shifts the process to step S12.

In this way, the control part 19 controls the transport part 21 to transport the second medium 99B that was recorded on its front surface by the recording part 22, to the inversion path 90 during a state in which the first medium 99A that was recorded on its front surface is stopped in the inversion path 90. In particular, the control part 19 stops the first medium 99A in the first inversion path 91 for a stop time based on the feed interval at which the medium 99 is fed. Thereafter, the control part 19 controls the transport part 21 to re-transport the first medium 99A from the inversion path 90 to the recording path 96.

Specifically, when the medium 99 is the second size or the third size, the control part 19 controls the first inversion drive part 55 and the second inversion drive part 56 to stop the first medium 99A in the first inversion path 91 and in the second inversion path 92. The control part 19 controls the third inversion drive part 57 to transport the second medium 99B to the third inversion path 93 during a state in which the first medium 99A is stopped in the first inversion path 91 and the second inversion path 92.

Thereafter, the control part 19 controls the first inversion drive part 55 and the second inversion drive part 56 to re-transport the first medium 99A from the first inversion path 91 to the recording path 96. The control part 19 controls the first inversion drive part 55, the second inversion drive part 56, and the third inversion drive part 57 so as to transport the second medium 99B from the third inversion path 93 to the second inversion path 92 and to transport the second medium 99B from the second inversion path 92 to the first inversion path 91.

When the medium 99 is the first size, the control part 19 controls the first inversion drive part 55 to stop the first medium 99A in the first inversion path 91. The control part 19 controls the second inversion drive part 56 to transport the second medium 99B to the second inversion path 92 during a state in which the first medium 99A is stopped in the first inversion path 91.

The control part 19 controls the third inversion drive part 57 to transport the third medium 99C to the third inversion path 93 during a state in which the first medium 99A is stopped in the first inversion path 91 and also the second medium 99B is stopped in the second inversion path 92.

Thereafter, the control part 19 controls the first inversion drive part 55 to re-transport the first medium 99A from the first inversion path 91 to the recording path 96. The control part 19 controls the first inversion drive part 55, the second inversion drive part 56, and the third inversion drive part 57 to transport the second medium 99B from the second inversion path 92 to the first inversion path 91 and to transport the third medium 99C from the third inversion path 93 to the second inversion path 92.

In particular, the control part 19 sets the circulation upper limit number of sheets to be larger when the medium 99 is the first size than when the medium 99 is the second size or the third size. The control part 19 sets the standby upper limit number of sheets to be larger when the medium 99 is the first size than when the medium 99 is the second size or the third size.

### Operations and Effects of First Embodiment

The operations and effects of the first embodiment will be described.

(1-1) The control part 19 causes the second medium 99B that was recording on its front surface to be transported to the inversion path 90 during a state in which the first medium 99A that was recording on its front surface is stopped in the inversion path 90. The control part 19 causes the first medium 99A to be re-transported from the inversion path 90 to the recording path 96. According to this configuration, before the first medium 99A that was recorded on its front surface is re-transported to the recording path 96, the second medium 99B that was recorded on its front surface can be transported to the inversion path 90 during a state in which the first medium 99A is stopped in the inversion path 90. Therefore, the second medium 99B that was recorded on its front surface can be smoothly transported to the inversion path 90 during the period from when recording is performed on the front surface of the first medium 99A to when recording is performed on the rear surface of the first medium 99A. By this, throughput can be improved. Therefore, it is possible to improve user convenience.

(1-2) The control part 19 controls the third inversion drive part 57 to transport the second medium 99B to the third inversion path 93 during a state where the first inversion drive part 55 and the second inversion drive part 56 are controlled to stop the first medium 99A in the first inversion path 91. According to this configuration, by controlling the first inversion drive part 55, the second inversion drive part 56, and the third inversion drive part 57, the control part 19 can smoothly transport the second medium 99B to the third inversion path 93 during a state in which the first medium 99A is stopped in the first inversion path 91. By this, throughput can be improved. Therefore, it is possible to improve user convenience.

(1-3) When the medium 99 is the first size, the control part 19 controls the second inversion drive part 56 and the third inversion drive part 57 to transport the second medium 99B from the third inversion path 93 to the second inversion path 92 during a state in which the first medium 99A is stopped in the first inversion path 91. According to this configuration, by controlling the first inversion drive part 55, the second inversion drive part 56, and the third inversion drive part 57, the control part 19 can smoothly transport the second medium 99B to the second inversion path 92 during a state in which the first medium 99A is stopped in the first inversion path 91. By this, throughput can be improved. Therefore, it is possible to improve user convenience.

(1-4) When the medium 99 is the first size, the control part 19 controls the third inversion drive part 57 to transport the third medium 99C to the third inversion path 93 during a state where the first medium 99A is stopped in the first inversion path 91 and the second medium 99B is stopped in the second inversion path 92. With this configuration, the control part 19 can smoothly transport the third medium 99C to the third inversion path 93 during a state where the first medium 99A is stopped in the first inversion path 91 and the second medium 99B is stopped in the second inversion path 92. By this, throughput can be improved. Therefore, it is possible to improve user convenience.

(1-5) The control part 19 stops the first medium 99A in the first inversion path 91 for a stop time based on the feed interval at which the medium 99 is fed. According to this configuration, the medium 99 in the first inversion path 91 can be re-transported to the recording path 96 at a timing based on the feed interval of the medium 99 fed from the feeding part 20 to the transport part 21. By this, it is possible to suppress contact between the medium 99 to be fed and the medium 99 to be re-transported. Therefore, it is possible to improve throughput while increasing the reliability of transporting the medium 99. Therefore, it is possible to improve user convenience.

(1-6) The control part 19 can stop transport of the medium 99 in at least a part of the supply path 95, the recording path 96, the inversion path 90, and the discharge path 97. According to this configuration, it is possible to stop transport of the medium 99 at an arbitrary timing in at least a part of the supply path 95, the recording path 96, the inversion path 90, and the discharge path 97. Therefore, it is possible to perform control related to transport of the medium 99 according to the situation.

(1-7) The control part 19 changes the stop time for stopping the medium 99 in the inversion path 90 while stopping transport of the medium 99 in at least one of the supply path 95, the recording path 96, and the discharge path 97. According to this configuration, the timing at which the medium 99 in the first inversion path 91 is re-transported to the recording path 96 can be changed in accordance with stopping of the medium 99 in at least one of the supply path 95, the recording path 96, and the discharge path 97.

(1-8) The control part 19 increases the number of sheets of the medium 99 that can exist in the transport path 98 when the length of the medium 99 in the transport direction D is the first length, compared to when the length of the medium 99 in the transport direction D is the second length. According to this configuration, the number of sheets of the medium 99 that can exist in the transport path 98 can be changed according to the length of the medium 99 in the transport direction D. Therefore, by providing diversity regarding transport of the medium 99 in the transport path 98 according to the length of the medium 99 in the transport direction D, it is possible to improve throughput. Therefore, it is possible to improve user convenience.

(1-9) The control part 19 increases the number of sheets of the medium 99 that can exist in the inversion path 90 when the length of the medium 99 in the transport direction D is the first length, compared to when the length of the medium 99 in the transport direction D is the second length. According to this configuration, the number of sheets of the medium 99 that can exist in the inversion path 90 can be changed according to the length of the medium 99 in the transport direction D. Therefore, by providing diversity regarding transport of the medium 99 in the transport path 98 according to the length of the medium 99 in the transport direction D, it is possible to improve throughput. Therefore, it is possible to improve user convenience.

(1-10) The length of the inversion path 90 in the transport direction D is longer than twice the maximum-length medium 99 in the transport direction D that can be transported by the transport part 21. According to this configuration, at least two sheets of the medium 99 can be present in the inversion path 90.

(1-11) The length of the inversion path 90 in the transport direction D is longer than three times the minimum-length medium 99 in the transport direction D that can be transported by the transport part 21. According to this configuration, at least three sheets of the medium 99 can be present in the inversion path 90 as long as the length of the medium 99 in the transport direction D is the minimum length.

(1-12) When performing maintenance of the recording part 22, the control part 19 stops transport of the medium 99 in the inversion path 90 and changes the stop time for which the medium 99 is stopped in the inversion path 90. According to this configuration, it is possible to change the timing of re-transporting the medium 99 in the inversion path 90 to the recording path 96 in accordance with maintenance of the recording part 22.

### Second Embodiment

Next, a second embodiment will be described. In the following description, redundant descriptions of configurations identical to those of the previously described embodiment will be omitted or simplified, and configurations that differ from the previously described embodiment will be detailed.

In the second embodiment, the medium 99 may be re-transported from the first inversion path 91 to the recording path 96, with detection of the rear edge of the medium 99 by the sixth medium detection part 66 as the trigger. That is, the medium 99 may not be stopped across the predetermined stop time in the inversion path 90. The sixth medium detection part 66 may be an example of a medium detection part.

### Double-Sided Recording Control Process

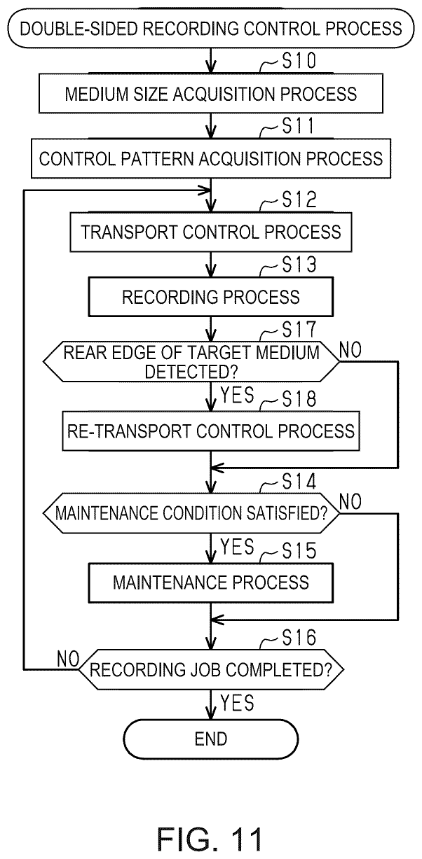

As shown in FIG. 11, in step S17, the control part 19 determines whether or not the rear edge of the target medium 99 is detected by the sixth medium detection part 66. The target medium 99 is a medium 99 in which the number of sheets of the medium 99 disposed in the inversion path 90 is the standby upper limit number of sheets. Specifically, in a case where the medium 99 is the second size or the third size, the target medium 99 is the medium 99 that has a standby upper limit number of sheets of two for the number of sheets of medium 99 disposed in the inversion path 90 by being transported to the third inversion path 93. In a case where the medium 99 is the first size, the target medium 99 is the medium 99 that has standby upper limit number of sheets of three for the number of sheets of medium 99 disposed in the inversion path 90 by being transported to the third inversion path 93.

When the control part 19 determines that the rear edge of the target medium 99 is not detected by the sixth medium detection part 66, the control part 19 does not execute step S18 and shifts the process to step S14. When the control part 19 determines that the rear edge of the target medium 99 has been detected by the sixth medium detection part 66, the control part 19 shifts the process to step S18.

In step S18, the control part 19 executes a re-transport control process. In the re-transport control process, the control part 19 stores data in the memory indicating that the medium 99 is to be re-transported from the first inversion path 91 to the recording path 96. By this, in step S12, the control part 19 controls the first inversion drive part 55 to re-transport the medium 99 from the first inversion path 91 to the recording path 96. In the present embodiment, the control part 19 may execute Steps S17 and S18 before Steps S12 and S13.

In this way, the control part 19 controls the transport part 21 so as to stop the medium 99 in the first inversion path 91 until the sixth medium detection part 66 detects the rear edge of the target medium 99.

Specifically, when the medium 99 is the second size or the third size, the control part 19 controls the transport part 21 to stop the first medium 99A in the first inversion path 91 until the sixth medium detection part 66 detects the rear edge of the second medium 99B. After the sixth medium detection part 66 detects the rear edge of the second medium 99B, the control part 19 controls the transport part 21 to re-transport the first medium 99A from the first inversion path 91 to the recording path 96.

When the medium 99 is the first size, the control part 19 controls the transport part 21 to stop the first medium 99A in the first inversion path 91 until the sixth medium detection part 66 detects the rear edge of the third medium 99C. The control part 19 controls the transport part 21 to stop the second medium 99B in the second inversion path 92 until the sixth medium detection part 66 detects the rear edge of the third medium 99C.

After the sixth medium detection part 66 detects the rear edge of the third medium 99C, the control part 19 controls the transport part 21 to re-transport the first medium 99A from the first inversion path 91 to the recording path 96. After the sixth medium detection part 66 detects the rear edge of the third medium 99C, the control part 19 controls the transport part 21 to transport the second medium 99B from the second inversion path 92 to the first inversion path 91.

### Operations and Effects of Second Embodiment

Operations and effects of the second embodiment will be described.

(2-1) The control part 19 stops the first medium 99A in the first inversion path 91 until the rear edge of the target medium 99 is detected at the branch position to the inversion path 90. After detecting the rear edge of the target medium 99 at the branching position to the inversion path 90, the control part 19 re-transports the first medium 99A from the first inversion path 91 to the recording path 96. According to this configuration, the first medium 99A can be re-transported to the recording path 96 after recognizing that the target medium 99 has been transported from the recording path 96 to the inversion path 90. By this, it is possible to suppress contact between the medium 99 transported from the recording path 96 to the third inversion path 93 and the medium 99 re-transported from the first inversion path 91 to the recording path 96. Therefore, it is possible to improve throughput while increasing the reliability of transporting the medium 99. Therefore, it is possible to improve user convenience.

### Third Embodiment

Next, a third embodiment will be described.

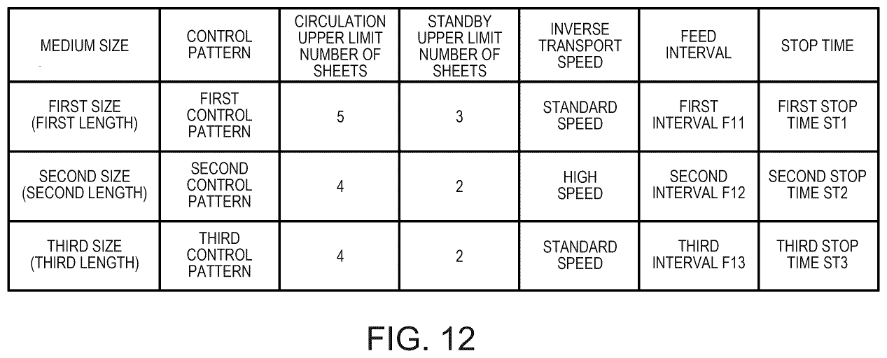

As shown in FIG. 12, in the third embodiment, the inverse transport speed may include a standard speed and a high speed. The high speed is a transport speed higher than the transport speeds in the supply path 95, the recording path 96, and the discharge path 97. In the second control pattern, the inverse transport speed may be set to the high speed.

Specifically, the second control pattern is a pattern for controlling the third inversion drive part 57 so as to transport the medium 99 in the first transport direction D1 at the high speed without driving the first inversion drive part 55 and the second inversion drive part 56 when the medium 99 is being transported from the recording path 96 to the third inversion path 93.

The second control pattern is a pattern for controlling the first inversion drive part 55, the second inversion drive part 56, and the third inversion drive part 57 so as to transport the medium 99 at the high speed from the third inversion path 93 to the second inversion path 92 and the first inversion path 91 in this order.

The second control pattern is a pattern for controlling the first inversion drive part 55 and the second inversion drive part 56 so as to re-transport the medium 99 to the recording path 96 at the high speed after stopping the medium 99 in the first inversion path 91 and the second inversion path 92 for the third stop time ST3. Here, the third stop time ST3 may be the same as or different from the third stop time ST3 of the first embodiment.

In this way, when the medium 99 is the first size or the third size, the control part 19 sets the transport speed at which the medium 99 is transported in the inversion path 90 to be lower than that when the medium 99 is the second size. The control part 19 sets the transport speed at which the medium 99 is transported in the inversion path 90 to be the same when the medium 99 is the first size and when the medium 99 is the third size. The control part 19 may set the transport speed at which the medium 99 is transported in the inversion path 90 to be the same as the transport speed at which the medium 99 is transported in the recording path 96 in both a case where the medium 99 is the first size and a case where the medium 99 is the third size.

The control part 19 may set the transport speed at which the medium 99 is transported in the inversion path 90 to be equal to or higher than the transport speed at which the medium 99 is transported in the recording path 96 in both cases where the medium 99 is the first size and where the medium 99 is the second size. That is, when the medium 99 is the first size, the second size, or the third size, the control part 19 may set the transport speed at which the medium 99 is transported in the inversion path 90 to be equal to or higher than the transport speed at which the medium 99 is transported in the recording path 96.

### Operations and Effects of Third Embodiment

Operations and effects of a third embodiment will be described.

(3-1) When the length of the medium 99 in the transport direction D is the first length, the transport speed at which the medium 99 is transported in the inversion path 90 is slower than when the length of the medium 99 in the transport direction D is the second length. According to this configuration, when the length of the medium 99 in the transport direction D is the second length, the medium 99 can be transported faster in the inversion path 90 than when the length of the medium 99 in the transport direction D is the first length. By this, the transport speed of the medium 99 in the inversion path 90 can be adjusted according to the length of the medium 99 in the transport direction D.

(3-2) When the length of the medium 99 in the transport direction D is the third length, the transport speed at which the medium 99 is transported in the inversion path 90 is slower than that when the length of the medium 99 in the transport direction D is the second length. According to this configuration, when the length of the medium 99 in the transport direction D is the second length, the medium 99 can be transported faster in the inversion path 90 than when the length of the medium 99 in the transport direction D is the third length. By this, the transport speed of the medium 99 in the inversion path 90 can be adjusted according to the length of the medium 99 in the transport direction D.

(3-3) The transport speed at which the medium 99 is transported in the inversion path 90 is the same when the length of the medium 99 in the transport direction D is the first length and when the length of the medium 99 in the transport direction D is the third length. According to this configuration, the medium 99 can be transported at the same transport speed when the length of the medium 99 in the transport direction D is the first length and when the length of the medium 99 in the transport direction D is the third length, and also at a slower transport speed in the inversion path 90 when the length of the medium 99 in the transport direction D is the second length. By this, the transport speed of the medium 99 in the inversion path 90 can be adjusted according to the length of the medium 99 in the transport direction D.

(3-4) The transport speed at which the medium 99 is transported in the inversion path 90 is equal to or higher than the transport speed at which the medium 99 is transported in the recording path 96 both when the length of the medium 99 in the transport direction D is the first length and when the length of the medium 99 in the transport direction D is the second length. According to this configuration, when the length of the medium 99 in the transport direction D is the first length or the second length, the medium 99 can be transported faster in the inversion path 90 than in the recording path 96. By this, the transport speed of the medium 99 can be adjusted according to the type of the transport path 98 of the medium 99. In addition, the interval between the medium 99 can be maintained.

### Modifications

The embodiments can be modified as follows. The embodiment and the following modifications can be implemented in combination with each other within a range where no technical contradiction occurs.
In the first embodiment, the stop time based on the feed interval may be set according to the timing at which the rear edge of the third medium 99C passes through the transport roller pair 35.
In the second embodiment, the medium 99 may be re-transported from the first inversion path 91 to the recording path 96, with detection of the rear edge of the medium 99 by the fifth medium detection part 65 as the trigger. The fifth medium detection part 65 may be an example of a medium detection part. In such a case, the control part 19 may control the transport part 21 to stop the medium 99 in the first inversion path 91 until the fifth medium detection part 65 detects the rear edge of the target medium 99.
In the second embodiment, the medium 99 may be re-transported from the first inversion path 91 to the recording path 96, with detection of the rear edge of the medium 99 by the fourth medium detection part 64 as the trigger. In such a case, the control part 19 may control the transport part 21 to stop the medium 99 in the first inversion path 91 until the fourth medium detection part 64 detects the rear edge of the target medium 99. This makes it possible to adjust to a small interval between the rear edge of the target medium 99 and the front edge of the first medium 99A to be re-transported to the recording path 96. The fourth medium detection part 64 may be an example of a medium detection part.
In the second embodiment, the medium 99 may be re-transported from the first inversion path 91 to the recording path 96, with elapse of a predetermined time after the rear edge of the medium 99 is detected by the fourth medium detection part 64 as the trigger. In such a case, the control part 19 may control the transport part 21 to stop the medium 99 in the first inversion path 91 until a predetermined time elapses after the fourth medium detection part 64 detects the rear edge of the target medium 99. The predetermined time may be a time that varies depending on the length of the medium 99 in the transport direction D and the transport speed of the medium 99. The predetermined time may be a time in which the rear edge of the target medium 99 and the front edge of the first medium 99A to be re-transported to the recording path 96 are at a predetermined interval. The predetermined interval may be a minimum interval suitable for recording on the medium 99.

As described above, by re-transporting the medium 99 from the first inversion path 91 to the recording path 96 on the basis of detection of the rear edge of the medium 99 by the fourth medium detection part 64, it is possible to perform recording on the medium 99 in the recording path 96 at an appropriate timing. Therefore, the throughput can be improved.
In the first embodiment and the second embodiment, when the medium 99 is re-transported from the first inversion path 91 to the recording path 96 on the basis of the detection of the rear edge of the medium 99 by the fourth medium detection part 64, the inverse transport speed may be changed according to the size of the medium 99 as in the third embodiment.

Specifically, the standby upper limit number of sheets is the same between the case where the medium 99 is the second size and the case where the medium 99 is the third size. On the other hand, when the medium 99 is the second size, the time that the medium 99 takes to pass through the recording path 96 is shorter than when the medium 99 is the third size. Therefore, the distance between the front edge of the second medium 99B and the rear edge of the first medium 99A that is re-transported to the recording path 96 may be different. For example, when the medium 99 is re-transported from the first inversion path 91 to the recording path 96 based on detection of the rear edge of the medium 99 by the fourth medium detection part 64, the first medium 99A is re-transported at a timing different from that in the second embodiment. Therefore, the distance between the front edge of the second medium 99B and the rear edge of the first medium 99A that is re-transported to the recording path 96 tends to be significantly different. For example, when the medium 99 is the second size, the first medium 99A is re-transported at an earlier timing than when the medium 99 is the third size. Therefore, the distance between the front edge of the second medium 99B and the rear edge of the first medium 99A that is re-transported to the recording path 96 tends to be long. In such a case, when the medium 99 is the second size, the timing at which the second medium 99B reaches the downstream end of the first inversion path 91 can be made earlier by increasing the inverse transport speed to be faster than when the medium 99 is the third size. This enables the distance between the front edge of the second medium 99B and the rear edge of the first medium 99A that is re-transported to the recording path 96 to be shortened. Therefore, the throughput can be further improved.

In particular, in a case where the inverse transport speed is the same between the case where the medium 99 is the second size and the case where the medium 99 is the third size, there is a concern that the front edge of the second medium 99B may not have reached the downstream end of the first inversion path 91 when the rear edge of the third medium 99C is detected by the fourth medium detection part 64. This situation may occur depending on the length in the transport direction D of the second size medium 99. Therefore, when the medium 99 is the second size, the second medium 99B can be re-transported from the first inversion path 91 to the recording path 96 at an optimal timing by increasing the inverse transport speed to be faster than when the medium 99 is the third size. Therefore, the throughput can be further improved.
In the third embodiment, the inverse transport speed may be set to the high speed in the first control pattern as well. The inverse transport speed may be set to be higher in the order of the first control pattern, the second control pattern, and the third control pattern. The inverse transport speed may be slower than the recording transport speed based on the control pattern.
In the third embodiment, when the inverse transport speed is set to a high speed, the control part 19 may transport the medium 99 at a high speed in a part of the first inversion path 91, the second inversion path 92, and the third inversion path 93. By this, when a part of the first inversion drive part 55, the second inversion drive part 56, and the third inversion drive part 57 is driven at a high speed, the load and power consumption of the drive part can be reduced compared to a case where the first inversion drive part 55, the second inversion drive part 56, and the third inversion drive part 57 are driven at a high speed. For example, since the third inversion drive part 57 needs to switch the rotation direction in order to switch back the medium 99, the load and power consumption of the drive part may be reduced by driving the third inversion drive part 57 at the standard speed.
The feed interval is different in the first control pattern, the second control pattern, and the third control pattern, but may be the same depending on the control pattern. Specifically, the feed interval may be the same in the second control pattern and the third control pattern.
The control part 19 may increase the number of sheets of the medium 99 that can exist in the transport path 98 when the length of the medium 99 in the transport direction D is the second length, compared to when the length of the medium 99 in the transport direction D is the third length. The control part 19 may set the number of sheets of the medium 99 that can be present in the transport path 98 to be the same in both a case where the length of the medium 99 in the transport direction D is the first length and a case where the length of the medium 99 in the transport direction D is the second length.
The control part 19 may increase the number of sheets of the medium 99 that can exist in the inversion path 90 when the length of the medium 99 in the transport direction D is the second length, compared to when the length of the medium 99 in the transport direction D is the third length. The control part 19 may set the number of sheets of the medium 99 that can exist in the inversion path 90 to be the same in both a case where the length of the medium 99 in the transport direction D is the first length and a case where the length of the medium 99 in the transport direction D is the second length.
In the first control pattern, when the second and subsequent sheets of the medium 99 are targets, the stop time in the second inversion path 92 and the stop time in the first inversion path 91 may be different from each other. That is, in the first control pattern, when the second and subsequent sheets of the medium 99 are the targets, the stop time in the first inversion path 91 may be a fifth stop time different from the fourth stop time ST4. The fifth stop time may be longer than the fourth stop time ST4 or may be shorter than the fourth stop time ST4.
The control pattern is a pattern in which the medium 99 is transported at the standard speed regardless of the presence or absence of the medium 99 in the supply path 95, the recording path 96, and the discharge path 97, but may be a pattern in which there is a period in which transport of the medium 99 is stopped in accordance with detection of the medium 99.
The first feed interval FI1 may be longer than or equal to the second feed interval FI2. The second feed interval FI2 may be longer than or equal to the third feed interval FI3. The second stop time ST2 may be longer than or equal to the third stop time ST3. The third stop time ST3 may be longer than or equal to the fourth stop time ST4.
Each of the first feed interval FI1, the second feed interval FI2, and the third feed interval FI3 may include a plurality of feed intervals. For example, the first feed interval FI1 may include two different feed intervals. The third feed interval FI3 may include three different feed intervals. In addition, the first feed interval FI1, the second feed interval FI2, and the third feed interval FI3 may be arbitrarily set by the control part 19 based on the length of the medium 99 in the transport direction D and the interval between sheets of medium 99.
When the medium 99 is the second size or the third size, the control part 19 may re-transport the first medium 99A in the first inversion path 91 to the recording path 96 before the second medium 99B is accommodated in the third inversion path 93. When the medium 99 is the first size, the control part 19 may re-transport the first medium 99A in the first inversion path 91 to the recording path 96 before the third medium 99C is accommodated in the third inversion path 93. By this, in the recording path 96, it is possible to suppress contact between the medium 99 transported from the supply path 95 and the medium 99 transported from the inversion path 90.
The maintenance condition may be satisfied at a cycle set by an instruction of the user. The maintenance condition may be satisfied by an instruction of the user. The maintenance condition may be satisfied with the medium 99 being transported from the recording path 96 to the inversion path 90 or to the discharge path 97 as the trigger. The maintenance condition may also be satisfied when the medium 99 is in the recording path 96.

In this way, when the maintenance part 23 performs maintenance of the recording part 22, the control part 19 may stop transport of the medium 99 in the supply path 95, the recording path 96, the discharge path 97, and the inversion path 90. That is, the control part 19 can stop transport of the medium 99 in at least a part of the supply path 95, the recording path 96, the discharge path 97, and the inversion path 90.
When the maintenance condition is satisfied, the control part 19 may separate the recording part 22 from the transport path 98 and move the maintenance part 23 to face the recording part 22. In this case, the medium support part 70 may not move between the support position and the retracted position. The medium support part 70 may not move.
The control part 19 may stop transport of the medium 99 in the transport path 98 regardless of whether or not the maintenance condition is satisfied. The control part 19 may stop transport of the medium 99 when an error occurs. In such a case, the control part 19 may extend the stop time of the medium 99 in the first inversion path 91 until the error is corrected.
The control part 19 may stop transport of the medium 99 in the transport path 98 when recording on the medium 99 by the recording part 22 is interrupted, even though the maintenance condition is not satisfied. In this way, when recording on the medium 99 by the recording part 22 is interrupted, the control part 19 may stop transport of the medium 99 in the supply path 95, the recording path 96, the discharge path 97, and the inversion path 90. That is, the control part 19 can stop transport of the medium 99 in at least a part of the supply path 95, the recording path 96, the discharge path 97, and the inversion path 90.

At this time, the control part 19 may extend the stop time for stopping transport of the medium 99 in the inversion path 90. That is, when recording on the medium 99 by the recording part 22 is interrupted, the control part 19 may change the stop time for stopping transport of the medium 99 in the inversion path 90.
Interrupting recording on the medium 99 by the recording part 22 may include stopping transport of the medium 99 in order to promote drying of the medium 99. Also, maintenance of the recording part 22 by the maintenance part 23 may be an example of when recording on the medium 99 by the recording part 22 is interrupted.
Interruption of recording on the medium 99 by the recording part 22 may include interrupting recording in order to secure a time for post-processing of the medium 99 in a post-processing device in a state where the post-processing device is connected to the recording device 11.
The control part 19 may stop transport of the medium 99 according to an instruction from the user. The control part 19 may stop transport of the medium 99 for an arbitrary time according to an instruction from the user. In such a case, the control part 19 may change the stop time of the medium 99 in the first inversion path 91.
The control part 19 may stop the medium 99 in the first inversion path 91 for a predetermined stop time regardless of the feed interval. The control part 19 may set the feed interval to be the same but set the stop time to be different depending on each control pattern. The control part 19 may set the same stop time but different feed intervals depending on each control pattern.
The recording drive part 52 may rotate the transport roller pair 35 and one of the pulleys 72 by separate drive parts. The recording drive part 52 may include a first recording drive part that rotates the transport roller pair 35 and a second recording drive part that rotates one of the pulleys 72.
At least one of the supply roller pair 34, the transport roller pair 35, the discharge roller pair 37, the first inversion roller pair 38, the second inversion roller pair 39, and the third inversion roller pair 40 may be configured by a drive roller and a driven roller. At least one of the supply roller pair 34, the transport roller pair 35, the discharge roller pair 37, the first inversion roller pair 38, the second inversion roller pair 39, and the third inversion roller pair 40 may be configured by a drive roller.
The transport part 21 may not include at least one of the supply drive part 51, the recording drive part 52, and the discharge drive part 54. At least one of the supply drive part 51, the recording drive part 52, and the discharge drive part 54 may be combined in a common manner.
The second inversion path 92 may be a switchback path. The first inversion path 91 may be a switchback path. The third inversion path 93 may not be a switchback path.
The inversion path 90 may not include either of the second inversion path 92 or the third inversion path 93. The inversion path 90 may include a path other than the first inversion path 91, the second inversion path 92, and the third inversion path 93. The first inversion path 91 and the second inversion path 92 may correspond to an example of a first inversion path, and the third inversion path 93 may correspond to an example of a second inversion path. That is, the second inversion path may be a switchback path.
The medium 99 may be a sheet of paper, a film or sheet made of resin, a composite film of resin and metal, a laminate film, a woven fabric, a nonwoven fabric, a metal foil, a metal film, a ceramic sheet, clothing, or the like.
The medium 99 as the target of control in the present embodiment may include all the medium 99 on which recording is performed by the recording device 11. The medium 99 as the target of control in the present embodiment may be a medium 99 on which the recording device 11 can execute a recording job including double-sided recording, among the medium 99 on which recording is performed by the recording device 11. The medium 99 as the target of control in the present embodiment may be a medium 99 of a specific size among the medium 99 on which recording is performed by the recording device 11. For example, the medium 99 as the target of control in the present embodiment may be a medium 99 of a standard size.
The liquid can be arbitrarily selected as long as recording on the medium 99 is possible by adhering the liquid to the medium 99. For example, ink includes ink in which particles of functional material made of solid material such as pigment or metal particles are dissolved, dispersed, or mixed in a solvent, and includes various compositions such as water-based ink, oil-based ink, gel ink, and hot-melt ink.
A lateral printer may be adopted as the recording device 11. A lateral type printer is a printer in which the carriage is movable in the two directions of the X-axis direction and the Y-axis direction. The recording device 11 is not limited to an ink jet printer, and may be a dot impact printer. The recording device 11 may be a laser printer.
As used herein, the phrase “at least any” means one or more of the desired options. As an example, if the number of options is two, then the phrase “at least any of” as used herein means only one option or both of the two options. As another example, if the number of options is three or more, the phrase “at least any” as used herein means only one option or a combination of any two or more arbitrary options.

### Notes

Hereinafter, technical ideas grasped from the above-described embodiment and modifications, and operations and effects thereof will be described. The present technical idea and the operations and effects thereof can be combined with each other within a technically consistent range.

### Note 1

A recording device includes a transport part configured to transport a medium in a transport direction along a transport path; a recording part configured to record an image on the medium transported by the transport part; and a control part configured to control the transport part and the recording part, wherein the transport path includes a recording path and an inversion path, the recording path is a path in which the recording part records on the medium, the inversion path is a path configured to re-transport the medium that was transported following the recording path, again through the recording path in a state in which front and rear surfaces of the medium are inverted, when the transport part sequentially transports a first medium and a second medium in this order and also the recording part performs recording on both surfaces of at least the first medium, the control part causes the second medium on which a first surface thereof was recorded on by the recording part to be transported to the inversion path during a state in which the first medium on which a first surface thereof was recorded on by the recording part is stopped in the inversion path and causes the first medium to be re-transported from the inversion path to the recording path.

According to this configuration, before the first medium on which recording is performed on the first surface is re-transported to the recording path, the second medium on which recording is performed on the first surface can be transported to the inversion path during a state where the first medium is stopped in the inversion path. Therefore, the second medium on which recording is performed on the first surface can be smoothly transported to the inversion path during the period from when recording is performed on the first surface of the first medium to when recording is performed on the second surface of the first medium. By this, throughput can be improved. Therefore, it is possible to improve user convenience.

### Note 2

The recording device may be such that the inversion path includes a first inversion path and a second inversion path, the first inversion path is located in the inversion path downstream from the second inversion path, the transport part includes a first inversion drive part that transports the medium in the first inversion path and a second inversion drive part that transports the medium in the second inversion path, and in a state of controlling the first inversion drive part so as to stop the first medium in the first inversion path, the control part controls the second inversion drive part so as to transport the second medium to the second inversion path.

According to this configuration, by controlling the first inversion drive part and the second inversion drive part, the control part can smoothly transport the second medium to the second inversion path during a state where the first medium is stopped in the first inversion path. By this, throughput can be improved. Therefore, it is possible to improve user convenience.

### Note 3

The recording device may be such that the inversion path includes a first inversion path, a second inversion path, and a third inversion path, the first inversion path is a path that is located in the inversion path downstream from the second inversion path and also that is a path for re-transporting the medium from the second inversion path to the recording path, the second inversion path is a path that is located in the inversion path downstream from the third inversion path and also that is a path for transporting the medium from the third inversion path to the first inversion path the third inversion path is a path that is for transporting the medium from the recording path and also for inverting the medium, the transport part includes a first inversion drive part for transporting the medium in the first inversion path, a second inversion drive part for transporting the medium in the second inversion path, and a third inversion drive part for transporting the medium in the third inversion path, and in a state of controlling the first inversion drive part so as to stop the first medium in the first inversion path, the control part controls the third inversion drive part so as to transport the second medium in the third inversion path.

According to this configuration, the same effect as that of Note 2 can be achieved. In addition, by controlling the first inversion drive part, the second inversion drive part, and the third inversion drive part, the control part can smoothly transport the third medium to the third inversion path during a state where the first medium is stopped in the first inversion path and the second medium is stopped in the second inversion path. By this, throughput can be improved. Therefore, it is possible to improve user convenience.

### Note 4

The recording device may further include a feeding part that feeds the medium to the transport part, wherein the control part stops the first medium in the first inversion path during a stop time based on a feed interval in which the medium is feed out by the feeding part.

According to this configuration, the medium in the first inversion path can be re-transported to the recording path at a timing based on the feed interval of the medium fed from the feeding part to the transport part. By this, it is possible to suppress contact between the fed medium and the re-transported medium. Therefore, it is possible to improve throughput while increasing the reliability of transporting the medium. Therefore, it is possible to improve user convenience. In addition, since it is not necessary to provide a medium detection part for determining the timing of re-transporting the medium, it is possible to suppress costs.

### Note 5

The recording device may further include a medium detection part that detects the medium at a branching position from the recording path to the inversion path, wherein the control part after a rear edge of the second medium is detected by the medium detection part, stops the first medium in the first inversion path and, after the medium detection part detects the rear edge of the second medium, controls the transport part so as to re-transport the first medium from the first inversion path to the recording path.

According to this configuration, the control part can re-transport the first medium to the recording path after recognizing that the second medium has been transported from the recording path to the inversion path. By this, it is possible to suppress contact between the medium transported from the recording path to the inversion path and the medium re-transported from the inversion path to the recording path. Therefore, it is possible to improve throughput while increasing the reliability of transporting the medium. Therefore, it is possible to improve user convenience.

### Note 6

The recording device may be such that the transport path includes a discharge path for discharging the medium transported from the recording path and the control part is configured to stop transport of the medium in at least a port of the recording path, the inversion path, and the discharge path.

According to this configuration, it is possible to stop transport of the medium at any arbitrary timing in at least a part of the recording path, the inversion path, and the discharge path. Therefore, it is possible to perform control related to transport of the medium according to the situation. As an example, transport of the medium can be stopped to dry the medium, for maintenance of the recording part, or the like.

### Note 7

The recording device may be such that the transport path includes a discharge path for discharging the medium transported from the recording path and the control part is configured to, when transport of the medium is stopped in at least one of the recording path or the discharge path, change a stop time during which the medium is stopped in the inversion path.

According to this configuration, it is possible to change the timing of re-transporting the medium in the first inversion path to the recording path in accordance with stopping transport of the medium in at least one of the recording path and the discharge path.

### Note 8

The recording device may be such that the control part is configured to increase the number of sheets of medium capable of existing in the transport path when a length of the medium in a transport direction is a first length, compared to when a length of the medium in the transport direction is a second length longer than the first length.

According to this configuration, the number of sheets of medium that can be present in the transport path can be changed according to the length of the medium in the transport direction. Therefore, it is possible to improve throughput by providing diversity regarding transport of the medium in the transport path according to the length of the medium in the transport direction. Therefore, it is possible to improve user convenience.

### Note 9

The recording device may be such that the control part is configured to increase the number of sheets of medium capable of existing in the inversion path when a length of the medium in a transport direction is a first length, compared to when a length of the medium in the transport direction is a second length longer than the first length.

According to this configuration, the number of sheets of medium that can exist in the inversion path can be changed according to the length of the medium in the transport direction. Therefore, it is possible to improve throughput by providing diversity regarding transport of the medium in the transport path according to the length of the medium in the transport direction. Therefore, it is possible to improve user convenience.

### Note 10

The recording device may be such that a length of the inversion path in the transport direction is more than two times a maximum length in the transport direction of medium transportable by the transport part.

According to this configuration, at least two sheets of medium can be present in the inversion path.

### Note 11

The recording device may be such that a length of the inversion path in the transport direction is more than three times a minimum length in the transport direction of medium transportable by the transport part.

According to this configuration, at least three sheets of medium can be present in the inversion path as long as the length of the medium in the transport direction is the minimum length.

### Note 12

The recording device may be such that the control part is configured to slow down transport speed at which the medium is transported in the inversion path when a length of the medium in a transport direction is a first length, compared to when a length of the medium in the transport direction is a second length that is longer than the first length.

According to this configuration, when the length of the medium in the transport direction is the second length, the medium can be transported faster in the inversion path than when the length of the medium in the transport direction is the first length. By this, the transport speed of the medium in the inversion path can be adjusted according to the length of the medium in the transport direction.

### Note 13

The recording device may be such that the control part is configured to slow down transport speed at which the medium is transported in the inversion path when a length of the medium in a transport direction is the third length that is longer than the second length, compared to when a length of the medium in the transport direction is the second length.

According to this configuration, when the length of the medium in the transport direction is the second length, the medium can be transported faster in the inversion path than when the length of the medium in the transport direction is the third length. By this, the transport speed of the medium in the inversion path can be adjusted according to the length of the medium in the transport direction.

### Note 14

The recording device may be such that the control part is configured to set the transport speed at which the medium is transported in the inversion path to be the same when a length of the medium in a transport direction is the first length and when a length of the medium in the transport direction is the third length.

According to this configuration, the medium can be transported at the same transport speed and faster than when the length of the medium in the transport direction is the second length in the inversion path, when the length of the medium in the transport direction is the first length and when the length of the medium in the transport direction is the third length. By this, the transport speed of the medium in the inversion path can be adjusted according to the length of the medium in the transport direction.

### Note 15

The recording device may further include a recording drive part configured to transport the medium in the recording path, wherein the control part is configured to set the transport speed at which the medium is transported in the inversion path to be equal to or greater than a transport speed of the medium in the recording path when either a length of the medium in a transport direction is the first length or when a length of the medium in the transport direction is the second length.

According to this configuration, when the length of the medium in the transport direction is the first length or the second length, the medium can be transported faster in the inversion path than in the recording path. By this, the transport speed of the medium can be adjusted according to the type of medium in the transport path.

### Note 16

The recording device may be such that the control part stops transport of the medium in the inversion path while recording by the recording part is interrupted, and changes a stop time at which the medium is stopped in the inversion path.

According to this configuration, in a case where it is necessary to interrupt recording by the recording part, it is possible to change the timing of re-transporting the medium in the inversion path to the recording path.

### Note 17

The recording device may further include a maintenance part that performs maintenance of the recording part, wherein the control part stops transport of the medium in the inversion path while the maintenance part is performing maintenance on the recording part, and changes a stop time at which the medium is stopped in the inversion path.

According to this configuration, it is possible to change timing of re-transporting the medium in the inversion path to the recording path according to maintenance of the recording part.

### Note 18

In a recording device control method, wherein recording device includes a transport part configured to transport a medium in a transport direction along a transport path; a recording part configured to record an image on the medium transported by the transport part; and the transport path includes a recording path and an inversion path, the recording path is a path in which the recording part records on the medium, the inversion path is a path configured to re-transport the medium that was transported following the recording path, again through the recording path in a state in which front and rear surfaces of the medium are inverted, the recording device control method includes when the transport part sequentially transports a first medium and a second medium in this order and also the recording part performs recording on both surfaces of at least the first medium, causing the second medium on which a first surface thereof was recorded on by the recording part to be transported to the inversion path during a state in which the first medium on which a first surface thereof was recorded on by the recording part is stopped in the inversion path and causing the first medium to be re-transported from the inversion path to the recording path.

According to this configuration, the same effect as that of Note 1 can be achieved.

### Note 19

The recording device control method may be such that the recording device further includes a feeding part that feeds the medium to the transport part, wherein the inversion path includes a first inversion path and a second inversion path, the first inversion path is located in the inversion path downstream from the second inversion path, and the transport part includes a first inversion drive part that transports the medium in the first inversion path and a second inversion drive part that transports the medium in the second inversion path, and the recording device control method further includes stopping the first medium in the first inversion path during a stop time based on a feed interval in which the medium is feed out by the feeding part.

According to this configuration, the same effect as that of Note 4 can be achieved.

### Note 20

The recording device control method may be such that the recording device further includes a medium detection part that detects the medium at a branching position from the recording path to the inversion path, the inversion path includes a first inversion path and a second inversion path, the first inversion path is located in the inversion path downstream from the second inversion path, and the transport part includes a first inversion drive part that transports the medium in the first inversion path and a second inversion drive part that transports the medium in the second inversion path, and the recording device control method further including after a rear edge of the second medium is detected by the medium detection part, stopping the first medium in the first inversion path and, after the medium detection part detects the rear edge of the second medium, controlling the transport part so as to re-transport the first medium from the first inversion path to the recording path.

According to this configuration, the same effect as that of Note 5 can be achieved.

What is claimed is:

1. A recording device comprising:
a transport part configured to transport a medium in a transport direction along a transport path;
a recording part configured to record an image on the medium transported by the transport part; and
a controller configured to control the transport part and the recording part, wherein
the transport path includes a recording path and an inversion path,
the recording path is a path in which the recording part records on the medium,
the inversion path is a path configured to re-transport the medium that was transported following the recording path, again through the recording path in a state in which front and rear surfaces of the medium are inverted,
when the transport part sequentially transports a first medium and a second medium in this order and also the recording part performs recording on both surfaces of at least the first medium,
the controller causes the second medium on which a first surface thereof was recorded on by the recording part to be transported to the inversion path during a state in which the first medium on which a first surface thereof was recorded on by the recording part is stopped in the inversion path and causes the first medium to be re-transported from the inversion path to the recording path.

2. The recording device according to claim 1, wherein
the inversion path includes a first inversion path and a second inversion path,
the first inversion path is located in the inversion path downstream from the second inversion path,
the transport part includes a first inversion driver that transports the medium in the first inversion path and a second inversion driver that transports the medium in the second inversion path, and
in a state of controlling the first inversion driver so as to stop the first medium in the first inversion path, the controller controls the second inversion driver so as to transport the second medium to the second inversion path.

3. The recording device according to claim 1, wherein
the inversion path includes a first inversion path, a second inversion path, and a third inversion path,
the first inversion path is a path that is located in the inversion path downstream from the second inversion path and also that is a path for re-transporting the medium from the second inversion path to the recording path,
the second inversion path is a path that is located in the inversion path downstream from the third inversion path and also that is a path for transporting the medium from the third inversion path to the first inversion path,
the third inversion path is a path that is for transporting the medium from the recording path and also for inverting the medium,
the transport part includes a first inversion driver for transporting the medium in the first inversion path, a second inversion driver for transporting the medium in the second inversion path, and a third inversion driver for transporting the medium in the third inversion path, and
in a state of controlling the first inversion driver so as to stop the first medium in the first inversion path, the controller controls the third inversion driver so as to transport the second medium in the third inversion path.

4. The recording device according to claim 2, further comprising:
a feeder that feeds the medium to the transport part, wherein
the controller stops the first medium in the first inversion path during a stop time based on a feed interval in which the medium is feed out by the feeder.

5. The recording device according to claim 2, further comprising:
a medium detection part that detects the medium at a branching position from the recording path to the inversion path, wherein
the controller after a rear edge of the second medium is detected by the medium detection part, stops the first medium in the first inversion path and, after the medium detection part detects the rear edge of the second medium, controls the transport part so as to re-transport the first medium from the first inversion path to the recording path.

6. The recording device according to claim 1, wherein
the transport path includes a discharge path for discharging the medium transported from the recording path and
the controller is configured to stop transport of the medium in at least a port of the recording path, the inversion path, and the discharge path.

7. The recording device according to claim 1, wherein
the transport path includes a discharge path for discharging the medium transported from the recording path and
the controller is configured to, when transport of the medium is stopped in at least one of the recording path or the discharge path, change a stop time during which the medium is stopped in the inversion path.

8. The recording device according to claim 1, wherein
the controller is configured to increase the number of sheets of medium capable of existing in the transport path when a length of the medium in a transport direction is a first length, compared to when a length of the medium in the transport direction is a second length longer than the first length.

9. The recording device according to claim 1, wherein
the controller is configured to increase the number of sheets of medium capable of existing in the inversion path when a length of the medium in a transport direction is a first length, compared to when a length of the medium in the transport direction is a second length longer than the first length.

10. The recording device according to claim 1, wherein
a length of the inversion path in the transport direction is more than two times a maximum length in the transport direction of medium transportable by the transport part.

11. The recording device according to claim 1, wherein
a length of the inversion path in the transport direction is more than three times a minimum length in the transport direction of medium transportable by the transport part.

12. The recording device according to claim 1, wherein
the controller is configured to slow down transport speed at which the medium is transported in the inversion path when a length of the medium in a transport direction is a first length, compared to when a length of the medium in the transport direction is a second length that is longer than the first length.

13. The recording device according to claim 12, wherein
the controller is configured to slow down transport speed at which the medium is transported in the inversion path when a length of the medium in a transport direction is a third length that is longer than the second length, compared to when a length of the medium in the transport direction is the second length.

14. The recording device according to claim 13, wherein
the controller is configured to set the transport speed at which the medium is transported in the inversion path to be the same when a length of the medium in a transport direction is the first length and when a length of the medium in the transport direction is the third length.

15. The recording device according to claim 12, further comprising:
a recording driver configured to transport the medium in the recording path, wherein
the controller is configured to set the transport speed at which the medium is transported in the inversion path to be equal to or greater than a transport speed of the medium in the recording path when either a length of the medium in a transport direction is the first length or when a length of the medium in the transport direction is the second length.

16. The recording device according to claim 1, wherein
the controller stops transport of the medium in the inversion path while recording by the recording part is interrupted, and changes a stop time at which the medium is stopped in the inversion path.

17. The recording device according to claim 16, further comprising:
a maintenance part that performs maintenance of the recording part, wherein
the controller stops transport of the medium in the inversion path while the maintenance part is performing maintenance on the recording part, and changes a stop time at which the medium is stopped in the inversion path.

18. A recording device control method for a recording device, the recording device including
a transport part configured to transport a medium in a transport direction along a transport path;
a recording part configured to record an image on the medium transported by the transport part; and
the transport path includes a recording path and an inversion path, wherein
the recording path is a path in which the recording part records on the medium,
the inversion path is a path configured to re-transport the medium that was transported following the recording path, again through the recording path in a state in which front and rear surfaces of the medium are inverted,
the recording device control method comprising:
when the transport part sequentially transports a first medium and a second medium in this order and also the recording part performs recording on both surfaces of at least the first medium,
causing the second medium on which a first surface thereof was recorded on by the recording part to be transported to the inversion path during a state in which the first medium on which a first surface thereof was recorded on by the recording part is stopped in the inversion path and causing the first medium to be re-transported from the inversion path to the recording path.

19. The recording device control method according to claim 18, wherein
the recording device further includes a feeder that feeds the medium to the transport part,
the inversion path includes a first inversion path and a second inversion path,
the first inversion path is located in the inversion path downstream from the second inversion path,
the transport part includes a first inversion driver that transports the medium in the first inversion path and a second inversion driver that transports the medium in the second inversion path, and
the recording device control method further includes stopping the first medium in the first inversion path during a stop time based on a feed interval in which the medium is feed out by the feeder.

20. The recording device control method according to claim 18, wherein
the recording device further includes a medium detector that detects the medium at a branching position from the recording path to the inversion path,
the inversion path includes a first inversion path and a second inversion path,
the first inversion path is located in the inversion path downstream from the second inversion path,
the transport part includes a first inversion drive part that transports the medium in the first inversion path and a second inversion driver that transports the medium in the second inversion path, and
the recording device control method further including
after a rear edge of the second medium is detected by the medium detector, stopping the first medium in the first inversion path and, after the medium detector detects the rear edge of the second medium, controlling the transport part so as to re-transport the first medium from the first inversion path to the recording path.
